(19) United States
(12) Patent Application Publication
(10) Pub. No.: US 2017/0032682 A1
(43) Pub. Date: Feb. 2, 2017

(54) AVIATION INFORMATION MANAGEMENT SYSTEM FOR PRIVATE AIR CARRIAGE AND UNSCHEDULED FLIGHT OPERATIONS

(71) Applicant: Martin J. Moser, Castle Rock, CO (US)

(72) Inventor: Martin J. Moser, Castle Rock, CO (US)

(21) Appl. No.: 14/860,453

(22) Filed: Sep. 21, 2015

Related U.S. Application Data
(60) Provisional application No. 62/172,695, filed on Jun. 8, 2015.

(51) Int. Cl. G08G 5/00; G06Q 10/02; G06F 9/54

(52) U.S. Cl. CPC G08G 5/0034; G06F 9/546; G06Q 10/02

(57) ABSTRACT

A system (100) is provided for management of information for unscheduled flight operations in various aviation business environments. The system (100) includes a central data store (102) that can exchanges information with each of a customer/user application platform (106), a pilot application platform (108), and a management application platform (110) via a central data store interface (104). The system allows for information sharing between applications that have previously been separate, if they existed at all, thereby reducing data entry redundancies, improving efficiency, and enabling better operations an

### CROSS-REFERENCE TO RELATED APPLICATION

This application is a non-provisional of U.S. Patent Application No. 62/172,695, entitled, “AVIATION INFORMATION MANAGEMENT SYSTEM FOR PRIVATE AIR CARRIAGE AND UNSCHEDULED FLIGHT OPERATIONS,” filed Jun. 8, 2015. The contents of the above-noted application is incorporated herein by reference as if set forth in full and priority to this application is claimed to the full extent allowable under U.S. law and regulations.

### FIELD OF THE INVENTION

The present invention relates to managing information for private air carriage and unscheduled flight operations in an aviation business such as charter aviation or “air taxi” and in other private air transportation involving passengers or cargo.

### BACKGROUND OF THE INVENTION

The aviation industry includes commercial airlines which typically conduct pre-set or “scheduled” flights and private air carriers and operators who conduct on-demand, ad hoc, or “unscheduled” flights. Examples of private, “unscheduled” aviation flights include emergency air operations (e.g., air ambulance, wildfire aircraft, catastrophe evacuation, etc.), ad hoc cargo flights, training flights, and charter or “air taxi” flights, and private air transportation as an owner of aircraft might conduct for pleasure or business on his own or through the flight department of his company. It will be appreciated that any scheduling of these flights and their related aircraft operations in these private-air environments is responsive to specific demands which are different from, or not present in, the typical environments of commercial airlines. The private-air environments targeted by the invention are sometimes called “unscheduled-flight operations,” or “unscheduled aviation” to distinguish private air carriage and private air transportation (which are addressed by the invention) from the air operations of commercial airlines (which this invention does not address).

The case of charter aviation is illustrative. While the commercial airlines sell individual seats on pre-set and pre-scheduled flights, charter aviation focuses on hiring or using entire aircraft for flights to be conducted on an ad hoc schedule that is not pre-set or fixed for the public at large. Charter aviation may be used for business travel, emergency flights, or other private purposes. In many cases, charter aviation is used where commercial airline travel would be inconvenient, inefficient, or impossible within the required timeframes or locations. Charter aviation businesses may fly to many destinations using a variety of aircraft. Customers and users of charter flights may schedule flights on an ad hoc basis as needs arise.

Management of information related to unscheduled aviation presents a number of challenges. There are many types of information that are entered and accessed by many parties for many purposes. It is crucial that this information is accurate in order to satisfy concerns related to safety, business management, and regulatory compliance. It is also important that this information can be stored and accessed multiple times in a timely and efficient manner given the dynamic nature of the unscheduled aviation business.

Considering again the example of charter aviation, the parties who may need to enter and access charter aviation information include, among others, charter aviation customers, charter aviation pilots, charter aviation users, and charter aviation business managers and personnel. Unlike commercial airline consumers, charter aviation customers and users—who may be direct charter clients or brokers—generally have not had the ability to access an automated charter aviation information system to request flights, obtain price quotes for flights, book flights, and obtain equipment and flight information. Rather, the automated information available to charter aviation customers and users has generally been limited to phone message systems, non-interactive video displays, and the like. In order to obtain more specific information or execute transactions, charter aviation customers and users have generally been required to talk to a charter aviation company employee or agent, thus limiting convenience and increasing costs.

Charter pilots may also require access to charter aviation information for a variety of purposes. Prior to a flight, pilots may need to access such information for scheduling or flight planning purposes. On the flight day, a pilot may enter a variety of flight information such as equipment identification, takeoff time and location, flight plan details, flight data (e.g., altitude, wind speed, fuel levels, aircraft loading/weights, total flight miles, etc.), landing time and location, and any other information related to the flight, personnel, and equipment. After a flight, a pilot may need to access the charter aviation information for purposes of reports and record keeping.

Aviation business managers also need to access charter aviation information. For example, planners need to match available equipment and resources to desired flights, customers, and users. Equipment managers need to ensure that all aircraft are receiving periodic inspections and servicing. Other operator personnel need to generate availability information and quotes, analyze performance/efficiency data, and deploy resources so as to best satisfy business and safety objectives.

Today, aviation businesses use a number of data systems to manage all of this information. Planners may use commercial scheduling platforms to match flight requests to equipment and resources. Equipment managers may use a variety of applications to track equipment status and generate necessary records and reports. Applications are also available for use by pilots in scheduling flights, registering flight plans, and logging flight information. Other business managers typically rely on a patchwork of off-the-shelf business management applications and proprietary software to generate the information needed to run the aviation business.

### SUMMARY OF THE INVENTION

It has been recognized that this current approach results in a number of problems in the context of the unscheduled aviation environment. First, it is often necessary to enter the same or similar information multiple times into multiple systems. For example, the scheduled or actual takeoff time might be entered by an employee working with a customer or user requesting a flight, by a planner in a scheduling application, by a pilot in a flight plan and then in a flight log, and by other personnel into various records systems. The process of entering the same or closely related information multiple times by multiple parties into multiple systems is inefficient, time-consuming, and increases the risk of data entry errors.

In addition, information entered into one system may not be readily be available to another system where it could be useful. For example, a variety of flight log information is typically maintained in flight log applications including, for example, flight departure and destination locations, elapsed flight time, total fuel used, etc. A business manager might wish to analyze such information to obtain performance and efficiency information. For example, it might be useful to understand why different pilots flying the same route with the same equipment use different amounts of fuel.

Moreover, because this information is siloed in discrete data systems, it is difficult to combine or process the data to obtain enhanced data for optimized management. Returning to the example of analyzing flight data for different pilots flying the same route using the same equipment, it will be appreciated that a variety of factors, other than different pilots, may affect fuel usage. These factors include, among others, wind speed, total aircraft weight, total flight time, etc. Conventionally, all of this information may be available in one system or another, but it is difficult to retrieve the data and account for differences, thereby confounding business managers trying to make useful comparisons.

It should be noted that the aviation industry is heavily regulated. Such regulations may govern, among other things, where the aircraft may fly, how long and often pilots may fly, how often aircraft must be inspected and serviced, and what records must be collected and maintained. Unscheduled aviation businesses are thus under tremendous pressure to manage information in a manner that meets the needs of this dynamic environment while also satisfying record keeping requirements and business needs.

The present invention is directed to an information system for unscheduled flight operations in various aviation business environments, and associated methodology, for improved management of information. The invention provides a number of applications that are specifically developed and optimized for this environment. Moreover, those applications are deployed around a common, central data store and interface that interconnects the application platforms so as to store and access information in the common data store. In this manner, data entered via one of the application platforms can be shared with the other application platforms, thereby substantially reducing or eliminating the need to re-enter specific items of data, improving efficiency, and reducing the potential for data entry errors. In addition, the invention allows for combination of data from different application platforms to generate enhanced information for improved aviation information analysis in unscheduled flight operations. In this regard, items of information may be normalized, re-formatted, and otherwise processed to facilitate combination or collective analysis of the data. The invention allows for increased automation of certain functions previously performed manually in the unscheduled-flight aviation environment. Moreover, the invention enables powerful searching for information and improved presentation thereof so as to simplify and improve management.

In accordance with one aspect of the present invention, a method and apparatus (“utility”) is provided for automated access to resource information, such as aircraft availability and price quotes, in an unscheduled-flight aviation environment. The utility involves receiving an electronic resource request relating to the unscheduled-flight environment where the resource request specifies at least route information and resource information concerning at least one attribute of desired aviation resources. For example, a customer may access a web portal and request a quote for a charter flight from a particular departure city to a destination city for a specified number of passengers. Similarly, a cargo customer may request a quote and specify the desired route and amount of cargo. In response to the electronic resource request, a processor is operative to automatically process the resource request to obtain the route information and resource information from the request, use the route information and resource information to identify one or more aircraft potentially suitable for satisfying the resource request, make a determination as to whether one of the identified aircraft is available and, based on that determination, generate an electronic response to the resource request. In this regard, the processor may perform a number of functions such as determining the locations of the identified aircraft, identifying aircraft that are unavailable due to maintenance or servicing, determining whether a crew is available for each identified aircraft, and otherwise determining whether each of the identified aircraft is cleared for flight on the date at issue. The processor may also use the route information and resource information together with other information, such as the type of aircraft at issue, the location of the aircraft, and rental rates for the aircraft, to automatically generate a price quote.

In accordance with another aspect of the present invention, at least a customer/user application platform, a pilot application platform, and a management application platform of an unscheduled-flight aviation business are linked to a common data store (residing in one or more machines) via a data store interface. The customer/user application platform may be used, for example, by a direct charter client or broker, to request quotes, obtain flight information, and execute contracts. Examples of flight information that may be entered or accessed in this regard include the desired flight departure and destination locations, the desired flight date and time, number of passengers, required amenities, desired/available aircraft, price quote, and contract and payment information. The platform may be web-based and can allow customers and users to enter information regarding a desired flight, request a quote, receive an automatically generated quote, digitally execute a contract, and provide payment. In addition, the customer/user application may learn and store information for brokers or individual clients concerning preferences, flight history, and the like to facilitate efficient repeat usage. The customer/user application platform may be embodied as a web-based application accessible via a computer or mobile data platform.

The pilot application platform can be used by pilots and crew to review flight plans, record takeoff and landing times, record expenses, and report maintenance issues. This platform may be also embodied as a web-based application and may be conveniently implemented as an iPad® application or other mobile device application for convenient use by pilots and crew members. It will be appreciated that the system may include many instantiations of the noted application platforms.

The management application platform may execute a variety of functions and be accessed via a desktop, laptop, or tablet computer or any other convenient data device. These functions may include flight record creation, flight planning, performance planning, risk management, filings with regulatory agencies, aircraft scheduling, crew scheduling, record keeping, maintenance scheduling and tracking, and a variety of other reporting, tracking, and transaction functions. In addition, the platform may include processing resources for matching flight requests to equipment and resources, identifying available inventory (e.g., empty legs) and desired resources (requests for potential flights), and accessing information from external sources (information on weather, security, etc.).

The data store interface interconnects the central data store to each of the customer/user application platform, pilot application platform, and management application platform to allow for exchange of information therebetween. In this regard, the interface defines a set of data fields for the flight information. For example, such fields may include fields for flight identification, takeoff time, landing time, course information, wind speed, equipment identification, inspection date, maintenance date, pilot identification, empty weight, total weight, fuel usage, and any other information related to a flight, the equipment, the personnel, the client, or associated business information (collectively, “flight information”).

The data store interface is further operative for receiving a first item of flight information from one of the noted application platforms and storing the item of flight information in the data store in conjunction with metadata indexing the flight information to one of the defined fields. For example, the pilot may enter the time 9:03 AM, MST, into a graphical user interface element of an iPad® application labeled “Takeoff Time.” In response, the data store interface may store 9:03 AM, MST (or similar information) in a database indexed to the field “Takeoff Time.” The information may further be linked to other data, such as data identifying the pilot, route, equipment, etc., so as to enable searching based on the various fields. Other items of information, such as maintenance records, pilot identification, requested route, or the like may be entered and processed in a similar fashion.

The data store interface is further operative for receiving a request for flight information from another one of the application platforms and generating a response based at least in part on the first item of flight information. Specifically, the data store interface processes the request to identify a data field implicated by the request and uses the data field to identify responsive information from the central data store. The data store interface then populates a record with data from the central data store based at least in part on the first item of flight information.

This is illustrated by a couple of examples. In a first example, a pilot or crew member may enter items of flight information for a given flight such a takeoff time, landing time, departure location, destination location, pilot identification, equipment identification, fuel usage, and the like using the pilot application platform. Subsequently, a manager using the management application platform may query the central data store using the data store interface to obtain information about historical fuel usage for a route having the specified departure location and destination location. A response may be provided to the manager that includes or uses the information entered by the pilot or crew member. It will be appreciated that it is not necessary for the manager to retrieve information directly from a separate flight log system or to re-enter information into a separate business management system.

In another example, a broker may submit a quote request using a customer/user application platform. The quote request may request pricing for a charter flight for four passengers from Denver, Colo. to Los Angeles, Calif. departing at 9:00 AM, MST on Jun. 1, 2015. In response, the management application platform may automatically query the central data store to identify available equipment and resources information using the information entered by the broker in the quote request. Again, it is unnecessary to re-enter that information from the quote request or to access a separate web platform to retrieve such information as that information is automatically entered into the central data store for use by the management application.

It will be appreciated that the customer/user application platform, the pilot application platform, the management application platform, and the central data store may all be web-based and may be implemented in a single machine or their functionality may be distributed over multiple machines in a single or separate locations.

Moreover, this automated and standardized system allows for deployment of a portal for sharing information and executing transactions involving any of multiple unscheduled aviation operators and any of multiple customers or users. For example, a user or customer can enter information into the portal requesting availability and price information for unscheduled flight resources from a given departure location to a given destination location in a specified time or date range. In response, the portal can query multiple operators for availability and price information which can then be presented to the user or customer, thereby enabling convenient access to information and useful comparisons. Similarly, an operator can use the platform to make information about available resources, e.g., empty legs, available to many potential users or customers. Such a portal also enables a variety of further business models such as auctions of unscheduled aviation resources or inventory.

In accordance with a further aspect of the invention, the central data store interface is operative for obtaining first and second items of processed flight information to facilitate combined analysis of the items of information. The items may originate from the same or different application platforms and may be processed to selectively filter the items or to account for differences in format, environment, or other factors. For example, a manager may wish to analyze historical fuel usage by different pilots on the same route using the same equipment. Using the system described above, the manager can readily identify records concerning fuel usage by identified pilots of the specified route. However, various factors such as wind speed and total weight may influence fuel usage. In accordance with the present invention, the retrieved information may be filtered to include information that is compatible with respect to specified factors (e.g., wind speed and/or total weight are the same or within a common range) or one or more items of information may be normalized or adjusted to compensate for differences in the specified factors (e.g., known algorithms are used to adjust for differences with respect to nominal values of wind speed or total weight). Similarly, the system may process data to account for differences in time zones, measuring systems, data formats, or any other characteristic that frustrates efforts towards comparison or other combined analysis.

In accordance with a still further aspect of the present invention, a utility is provided for use in generating an interface that graphically depicts status information for aviation resources in an unscheduled-flight aviation environment. The utility involves providing a central data store for storing information related to the unscheduled aviation environment. For example, the central data store may store information related to the aircraft location, required maintenance and service status for aircraft, the availability of crew, and other information related to the unscheduled aviation environment. The utility further involves receiving a request for aviation resource information including at least date information related to subject aviation resources. For example, in connection with scheduling flights for a given date, scheduling personnel may request information regarding the locations and status of certain aircraft on that date. Similarly, maintenance personnel may request information regarding all aircraft that are due for or scheduled for maintenance at the present time or in the upcoming week. A processor can then process the request to identify subject aviation resources, access the central data store based on the date information to obtain status information for the subject aviation resources, and generate a user interface graphically depicting the status information for the aviation resources. For example, in the case of a request concerning scheduling flights on a given date, the user interface may comprise a map showing the locations of aircraft together with color-coded or other information indicating status information. In this manner, personnel can access rich information in a form that is readily understood, thereby facilitating a variety of business objectives.

### BRIEF DESCRIPTION OF THE DRAWINGS

For a more complete understanding of the present invention and further advantages thereof, reference is now made to the following detailed description taken in conjunction with the drawings, in which:

FIG. 1 is a schematic diagram of an information management system in accordance with the present invention;

FIGS. 2A-2D show user interfaces that may be used in connection with a customer/user platform in accordance with the present invention;

FIG. 3 illustrates a pilot application platform in accordance with the present invention;

FIGS. 4A-4B illustrate user interface screens that may be presented in connection with a management application platform in accordance with the present invention;

FIG. 5 is a schematic diagram of an automated and centralized platform for distribution of information and execution of contracts in accordance with the present invention;

FIG. 6 is a schematic diagram of an application environment in accordance with the present invention;

FIG. 7 is a schematic diagram of a use case for an unscheduled flight operation system in accordance with the present invention;

FIGS. 8A-8C are a flowchart illustrating a flight planning process in accordance with the present invention;

FIGS. 9A-9C are a flow chart illustrating an automated quoting process in accordance with the present invention; and

FIG. 10 is a flowchart illustrating a process for identifying availability of aircraft in accordance with the present invention.

### DESCRIPTION OF THE INVENTION

In the following description, the invention is set forth in the context of an information management system for use in connection with unscheduled flight operations in various aviation environments. Particular examples are provided relating to charter aviation businesses, air cargo businesses, and deploying emergency aircraft. It should be appreciated, however, that the invention is useful in variety of other contexts including various contexts where aviation resources are identified and deployed in response to a specific request for resources where unscheduled flight operations are involved. Accordingly, the following description should be understood as exemplifying various aspects of the invention and not by way of limitation.

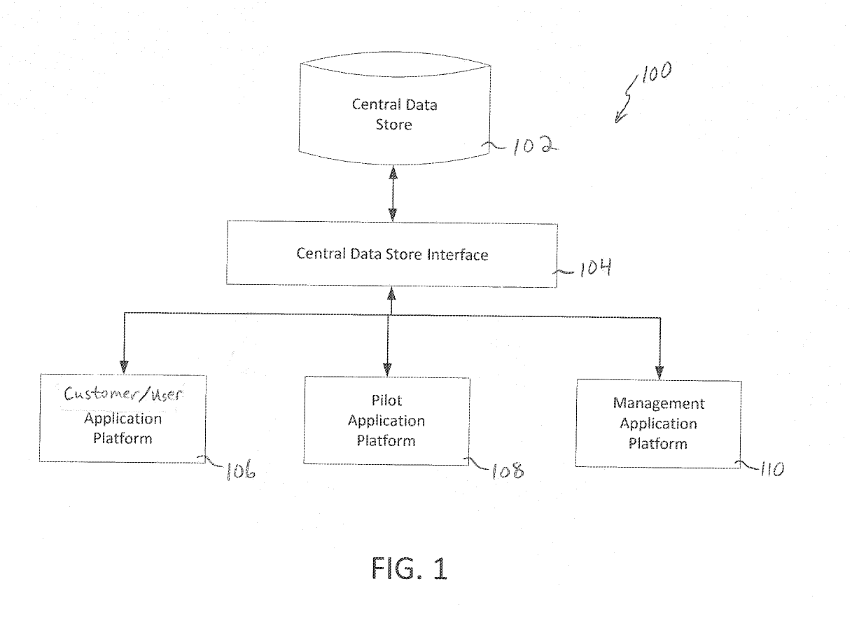

FIG. 1 illustrates a high level schematic diagram of an information management system 100 in accordance with the present invention. The system 100 is intended for managing information related to an unscheduled-flight aviation environment. The illustrated system 100 includes a central data store 102 that can exchange information with each of a customer/user application platform 106, a pilot application platform 108, and a management application platform 110. The platforms 106, 108, and 110 exchange information with the central data store 102 via a central data store interface 104. The system 100 enables access to and distribution of information across the platforms 106, 108, and 110 so as to reduce the need for data reentry and improve access to and analysis of data related to the unscheduled aviation environment.

The central data store 102 stores a variety of information related to the unscheduled-flight aviation environment. This information may include: equipment information such as available aircraft, locations of aircraft, and status of aircraft and crew; flight log data such as takeoff times, landing times, route information, aircraft weight, ground speed, wind speed, altitude, and the like; cost information such as fuel costs, equipment rental rates, crew costs, and materials and amenities costs; scheduling information such as scheduled flights, pending flights, empty legs, and flight requests; maintenance information such as scheduled and required maintenance and servicing for aircraft; report information; regulatory information; personnel tracking information; and any other information related to the unscheduled aviation environment.

The central data store interface 104 provides a variety of functionality related to storing, accessing, processing, and distributing information in relation to the data store 102. In this regard, the central data store interface may define a variety of fields of information such as takeoff time, wind speed, fuel costs, total weight, etc., and manage storage of information in the data store such that the data is indexed to metadata associating particular items of data with corresponding fields. The interface 104 further provides sorting, searching, and other database management functionality. The interface 104 can be utilized by each of the platforms 106, 108, and 110 to request and receive information from the central data store 102.

The customer/user application platform 106 can be used by direct customers, operators, or brokers to enter information into and access information from the central data store 102 and to obtain flight information. For example, the platform 106 may be embodied as a web portal that customers or users can use to check the availability of resources, schedule flights, request amenities such as meals, hotels and rental cars, execute booking contracts, and submit payment. The platform will be described in more detail below.

The pilot application platform 108 can be used by pilots and other crew members to enter information into and access information from the central data store 102 and to perform various functions. For example, pilots may access the data store 102 to view information regarding flights that have already been scheduled, record flight log information, manage their schedules, and generate flight documentation and records. Moreover, as will be understood from the description below, the system 100 is operative to automatically plan flights and execute regulatory filings. The pilot application platform 108 can be used by the pilot to view such flight plans. The pilot application platform 108 will also be described in more detail below.

The management application platform 110 can be used by various unscheduled-flight aviation business personnel to enter information into and access information from the central data store 102 as well as to perform a variety of business functions. For example, the management application platform 110 can be used by personnel or automated processing equipment to process quote requests, to view the status of equipment or crew, to perform profitably and cost analyses, to execute regulatory filings, and to generate reports among other things. The management application platform 110 will be described in more detail below.

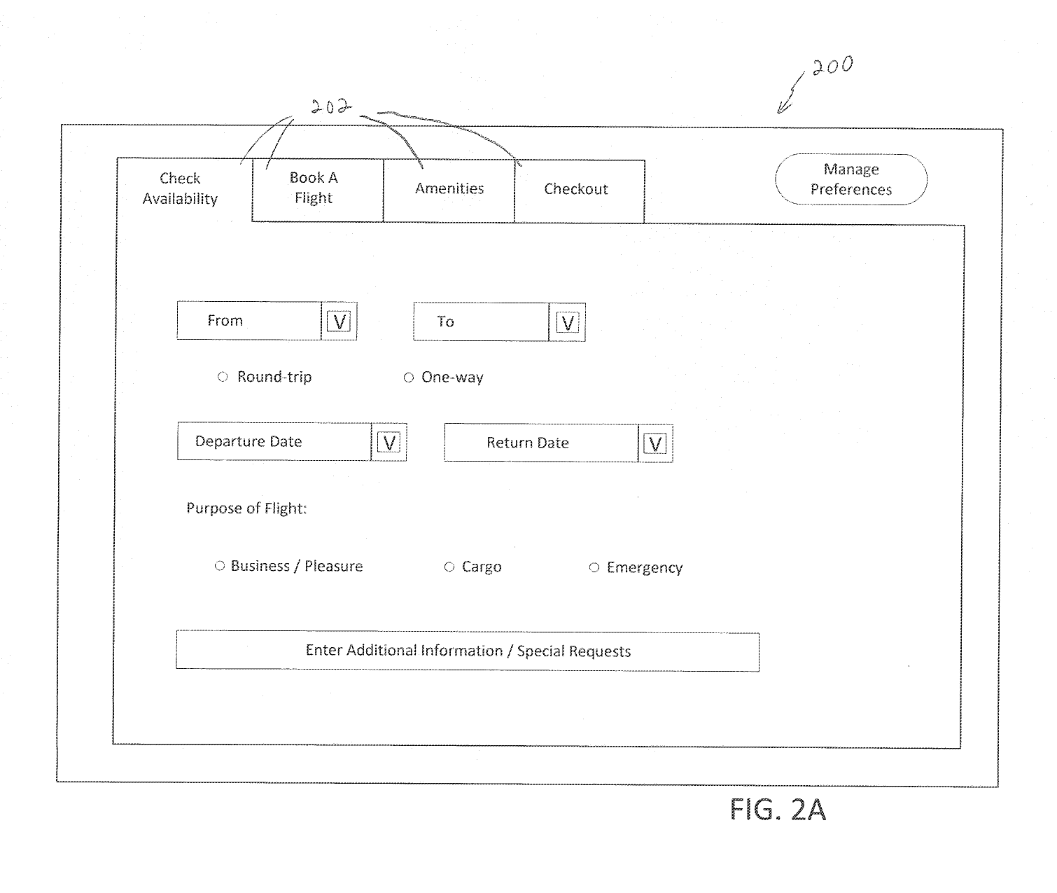

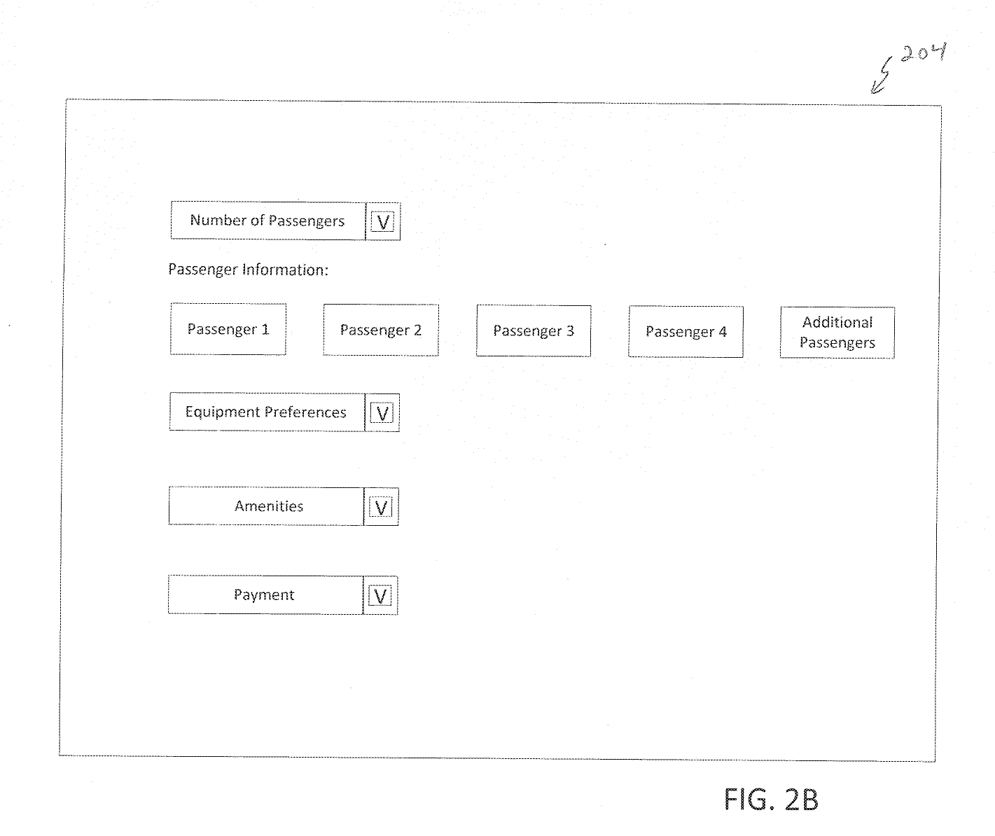

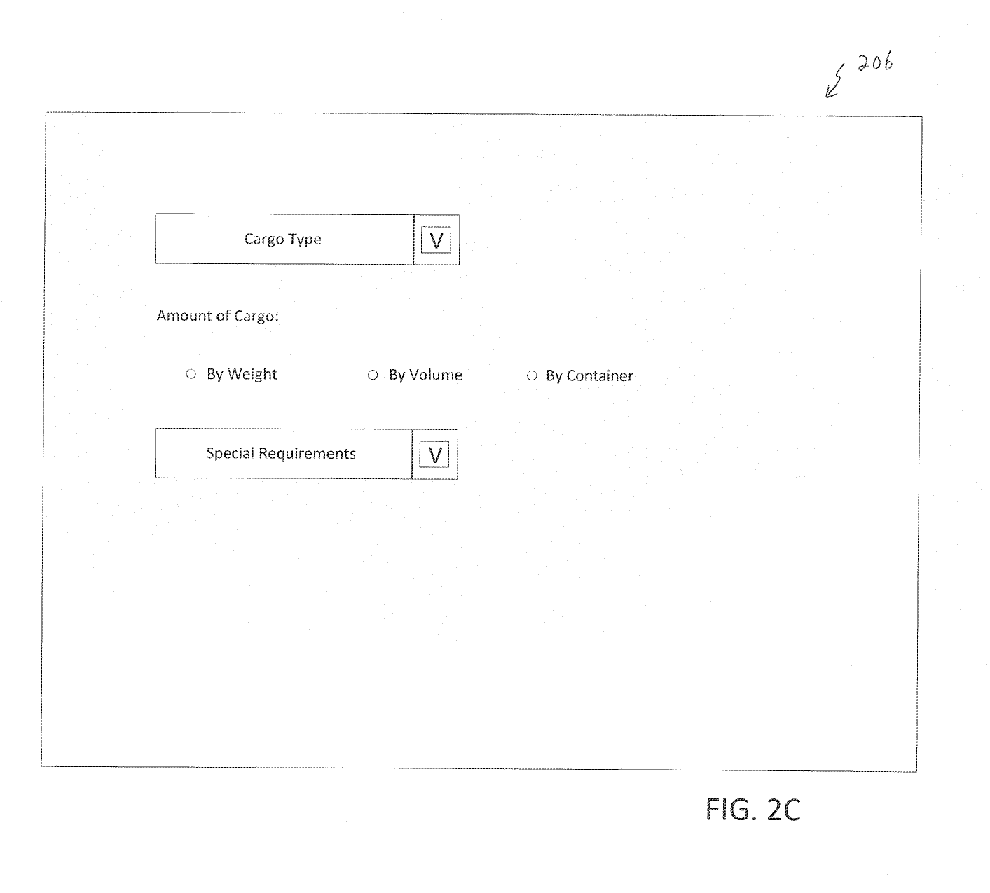

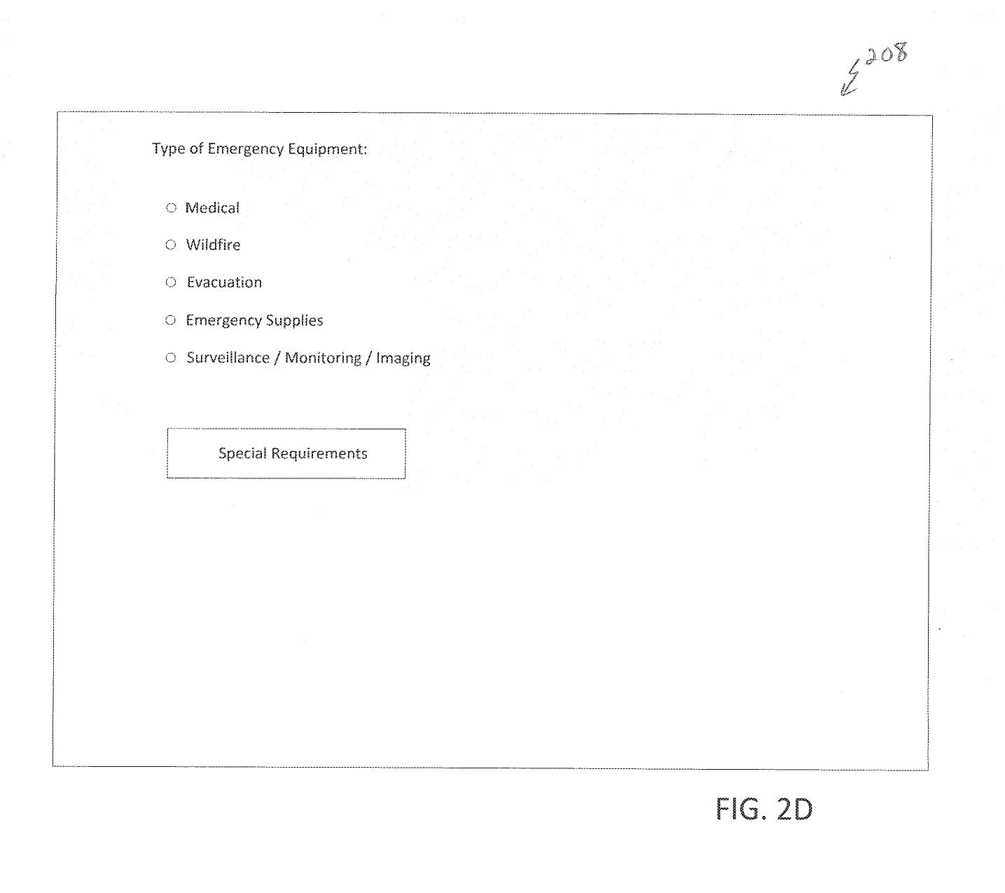

FIGS. 2A-2D illustrate user interfaces that may be presented in connection with the customer/user application platform. Referring first to FIG. 2A, a first user interface screen 200 is depicted. This user interface screen 200 may be presented as starting page of a customer/user portal hosted by an unscheduled aviation business or hosting service. The illustrated screen includes a number of tabs 202 that the customer or user may select to access associated functionality. In the illustrated implementation, these tabs include tabs for checking the availability of aircraft, for booking a flight, for contracting for amenities such as meals, rental cars, and hotels, and for checking out, for example, to submit payment or charge services to an existing account. The screen 200 also includes a button for entering or updating user preferences, e.g., relative to equipment, crew, payment method, rental cars, amenities, hotels, etc.

In the illustrated example, prompts associated with the “check availability” tab are illustrated. In this case, user interface elements are provided that enable the customer or user to input information regarding the departure and destination locations, whether the desired flight is a round-trip or one-way flight, and to enter information regarding the departure and return dates. The customer or user may also indicate whether the purpose of the flight is business/pleasure, cargo, or emergency. It will be appreciated that other purposes may be accommodated by the user interface screen 200. Finally, in the illustrated example, a box is provided for entering any additional information or special requests related to the desired flight. Similar prompts may be provided in connection with the other tabs 202. It should be appreciated that the types of information and layout illustrated are provided by way of example and any other information that is relevant to a particular unscheduled aviation environment may be accommodated in any desired layout.

The customer/user application platform may execute branching logic based on the information entered on the user interface screen 200. For example, as noted above, the customer or user may indicate whether the purpose of the flight is business/pleasure, cargo, or emergency. Different user interfaces may be presented depending on the purpose selected. Thus, FIG. 2B illustrates a user interface screen 204 that may be presented when the customer or user selects “business/pleasure” for the purpose of flight. In the case of the illustrated screen 204, the user may then be presented with graphical elements prompting the user to enter information regarding the number of passengers expected for the flight, to enter passenger information for each of the passengers such as name, address, and passport information, and to enter equipment preferences. With regard to equipment preferences, the customer or user may specify a particular aircraft, a particular type of aircraft, or other information required by the customer or user such as work resources, sleeping space, or the like. In the illustrated example, the customer or user can also enter information about amenities such as meals, movies, broadband access, liquor, or any other amenities that may be desired in connection with a flight. The illustrated user interface screen also includes an element to enter payment information such as credit card or account information.

FIG. 2C illustrates a user interface screen 206 that may be presented if a user indicates that the purpose of the flight is transportation of “cargo.” The screen 206 includes a prompt for the user to enter information about cargo type. A variety of kinds of information may be entered in this regard including whether any hazardous materials are included, whether the cargo is perishable, whether the cargo implicates any import or export regulations, the nature of the cargo (e.g., food products, electronic equipment, hardware, clothing, merchandise, etc.), or any other information regarding the type of cargo that may be required or desired by the aviation business. It will be appreciated that information regarding the amount of cargo will typically be required in order to identify suitable aircraft and generate pricing information. In this regard, the amount of cargo may be specified in various ways including by weight, by volume, or by container. In the last regard, the amount of cargo may be specified in relation to standardized cargo containers. In many cases, it may be necessary to specify the amount of cargo with regard to more than one category. For example, the customer or user may specify the number of standard cargo containers as well as total weight to be shipped. The illustrated screen 206 also includes an element for entering any special requirements such as the need for refrigeration, total weight of the cargo, total value of the cargo, whether insurance is required, or any other information of interest.

FIG. 2D illustrates a user interface screen 208 that may be presented when the customer or user selects “emergency” as the purpose of the flight. The illustrated screen 208 gives examples of different types of emergency equipment than may be selected by a user including medical (air ambulance or flight-for-life), wildfire, evacuation, emergency supplies, or surveillance/monitoring/imaging. The illustrated interface user screen 208 also includes a box for entering information regarding special requirements such as the need for fixed or rotary wing aircraft, any required medical equipment, supplies that need to be stocked, flight plans including any clearances that must be obtained and the like. It will be appreciated that many other types of information may be required or desired depending on the specific emergency environment.

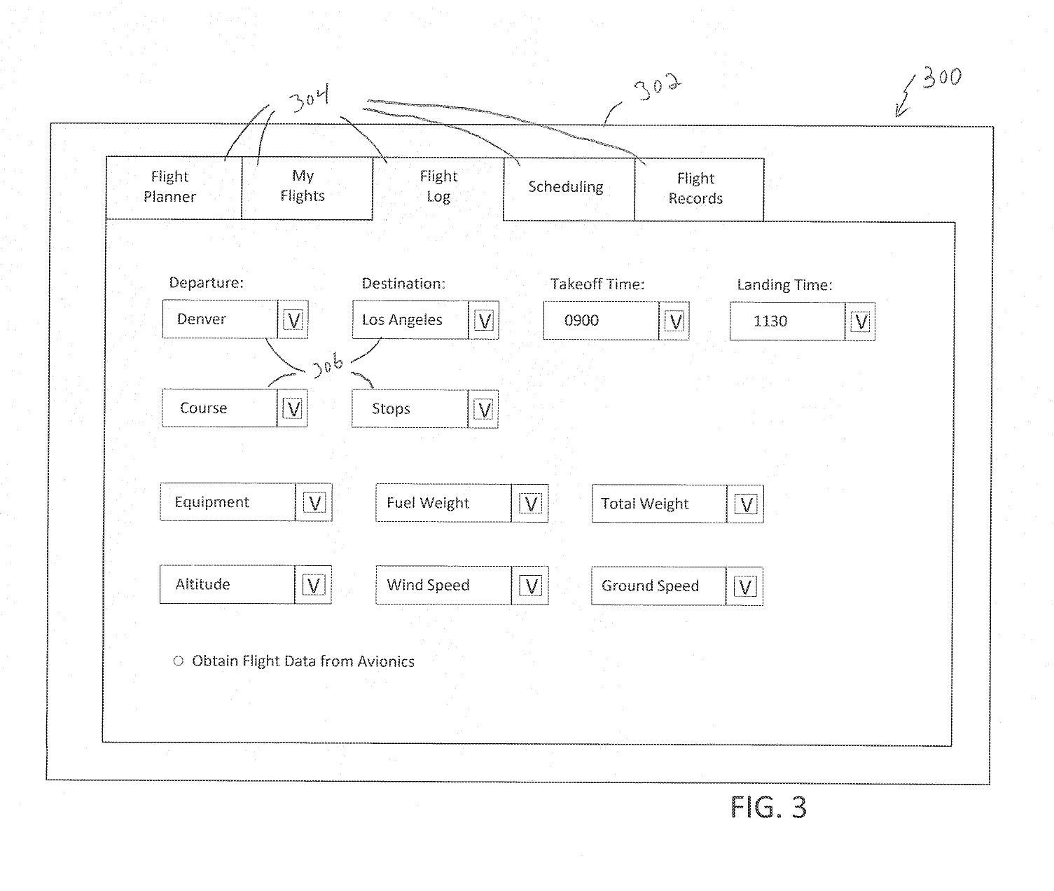

FIG. 3 illustrates a pilot application platform 300 that may be embodied in a tablet computer such as an iPad®, Droid® tablet, or the like. The platform 300 runs a pilot application that provides a user interface screen 302. The illustrated user interface screen 302 includes a number of tabs 304 that may be selected by the pilot or crew member to access functionality related to, for example, flight planning, the flights of that pilot, flight log, scheduling, and flight records. In the illustrated example, the user has selected the “flight log” tab 304. When the user selects the flight log tab 304, a number of flight log input elements 306 are presented. A variety of information may be accommodated in this regard. In addition, it should be appreciated that this information may be entered manually or may be imported from the aircraft avionics or another source. For example, the platform 300 may be imported from a control panel of the aircraft e.g., wirelessly or by way of a cable port. In the illustrated example, elements 306 are provided for entering information such as departure and destination locations, takeoff and landing times, course and any stops, equipment identification, fuel weight, total weight, altitude, wind speed, and ground speed. Again, it will be appreciated that many other types of information may be recorded in connection with a flight.

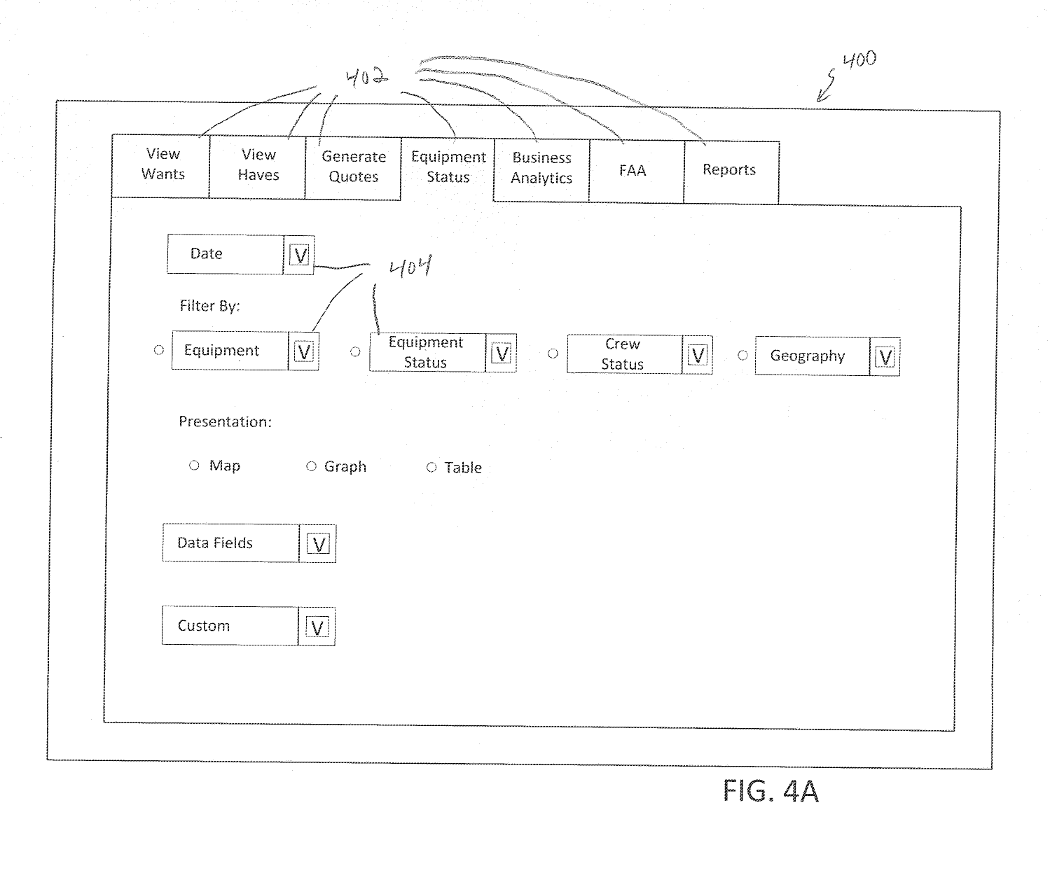

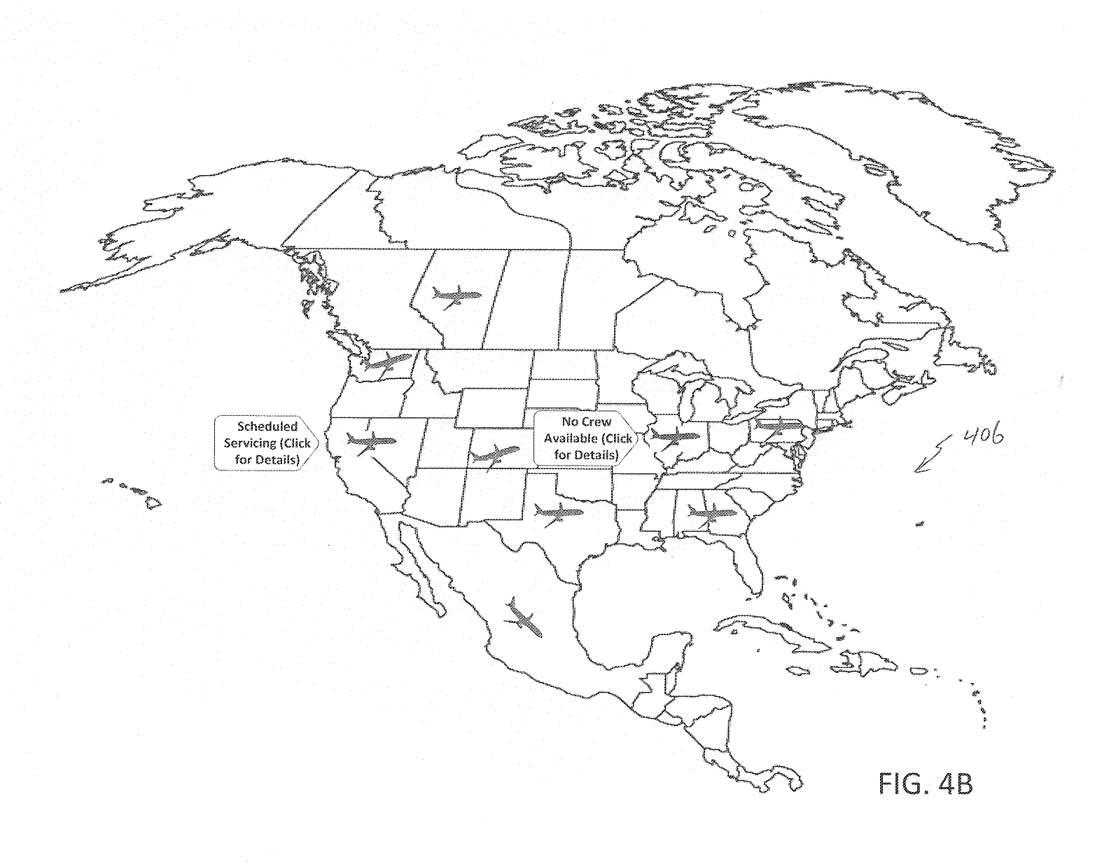

FIGS. 4A and 4B illustrate user interface screens that may be presented in connection with the management application platform. Referring first to FIG. 4A, a first user interface screen 400 is shown. The screen 400 includes a number of tabs 402 that may be selected by a user, such as unscheduled aviation business manager or employee, to execute a variety a functionality. In the illustrated example, this functionality includes a tab for viewing wants (e.g., regarding requested or desired flights), viewing haves (e.g., information regarding empty legs), generating quotes, obtaining information regarding equipment status, executing business analytics, viewing or generating FAA or other regulatory reports, and viewing or generating other reports.

In the illustrated example, the “equipment status” tab 402 has been selected. When this tab is selected in the illustrated example, a number of input elements 404 are presented. These elements 404 allow the user to request information in a variety of contexts such as scheduling flights, identifying equipment requiring maintenance, identify crews that are available or unavailable, accessing information regarding stressed inventory, or viewing status information for any other purpose.

The illustrated elements 404 include elements for specifying the date or date range for which status information is desired, and a variety of filtering options. For example, the user may wish to filter equipment status information in relation to equipment (e.g., by specifying fixed wing or rotary wing aircraft, passenger aircraft or cargo aircraft, aircraft size, aircraft model, etc.), equipment status (e.g., by specifying available, unavailable, maintenance or servicing status, in-use, etc.), crew status (e.g., by specifying available, unavailable, limited availability, etc.), and geography (e.g., by specifying country, region, city, etc.). The user may also provide information specifying how the equipment status information is to be presented including whether the information is to be presented in map form, in graph form, or in table form. It will be appreciated that many other presentation options are possible. In addition, the user may specify what data fields should be presented in the output. For example, a user may request equipment status information by color-coding, information regarding availability time windows, e.g., information regarding availability time limits for crew members, or other fields of information. The user can also enter custom information showing the soonest available aircraft, the lowest cost suitable aircraft, or other custom information.

FIG. 4B illustrates a user interface screen 406 that presents equipment status information. In this case, the equipment status information is presented in the form of a map with aircraft icons. The aircraft icons are shown at positions on the map corresponding to the current locations of the aircraft. In addition, the aircraft icons are color-coded to indicate equipment status. In the illustrated example, certain aircraft icons may be displayed in a first color (e.g., green) to indicate aircraft that are available and ready for flight at the date or within the time window otherwise specified. Red aircraft icons may be used to indicate aircraft that are not available, for example, because of scheduled servicing or lack of an available crew at the relevant time. Additional information regarding the status of any aircraft may be obtained by rolling over or clicking on the associated icon. In the case of an available aircraft, such additional information may include, for example, the specific location of the aircraft, the time window for which the aircraft is available, an identification of the aircraft, information regarding next service or maintenance date, or any information desired by the system operator. In the case of an unavailable aircraft, such additional information may indicate the reason for unavailability, the time window in which the aircraft will remain unavailable, an aircraft identification, a contact information for further details, or any other information. It will be appreciated that other types of information may be made available and the information may be customized as desired by a particular aviation business.

It will be appreciated that information entered in the user interface screens as described above for any of the application platforms can readily be associated with data fields based on the graphical element where the information was entered. For example, the central data store interface will recognize that a time entered in a graphical element designated “takeoff” is a takeoff time and can tag the time with appropriate metadata. Thus, the central data store interface can readily associate metadata with information entered by the user. This metadata can associate the information with any defined data fields such as takeoff time, wind speed, aircraft type, fuel costs, etc. This metadata can then be used to facilitate searching by field for any other purposes noted above.

Moreover, the information entered by way of any of these platforms can be stored in the central data store such that it can be accessed by other ones of the platforms. For example, if the user enters 0900 hours as the desired takeoff time for a particular flight, this information can be used by the management platform in planning a flight and can be used to prepopulate the takeoff time in the pilot application flight log (the actual takeoff time may be entered in a different field or entered in place of the prepopulated takeoff time). The illustrated system thus provides an efficient and powerful tool for data management in the unscheduled-flight aviation context. It will be appreciated that the system reduces the need to reenter information thus reducing the chances of data input errors. In addition, the types of information that are readily available for analysis are greatly increased. It is anticipated that, once these types of information are readily available, accessible, and combinable via a central data store, many new and different uses for the data will occur to managers and other parties. For example, as large amounts of data are accumulated, various statistical analyses will be possible to analyze profitability, safety, and consistency. The data may also be analyzed to identify anomalies, generate warnings, and meet reporting requirements.

In this regard, the system can also perform a variety of analyses related to safety risk management using the information noted above entered into the central data store and/or additional information entered into or accessed by the system for this purpose. For example, some factors that may be used by a risk management application are the length of runways at various airports, weather, topographic features at or near airports/flight paths, and experience levels of crew members. It will appreciated that many other factors are known or may be identified through manual or automated analysis and can be used by the risk management application. Moreover, relevant information may be loaded into the system or automatically harvested by the safety management application from the central data store or external sources.

The risk management system can use this information, as well as financial and other operations information, to identify and weigh risk factors. For example, the risk management system may identify particular routes, airports, crews, aircraft, types of flights, or combinations of the foregoing that exceed specified risk criteria. This information may be used to change flight offerings, price flights, change routing, retire equipment, change scheduling, or otherwise manage risk.

The information management system of the present invention also allows for creation of a marketplace for unscheduled aviation services whereby a customer/user can access and compare information from multiple operators in an automated fashion. It will be appreciated that this has not previously been possible in this environment. In particular, heretofore, customers/users have generally been limited to contacting unscheduled-flight aviation operators on an individual basis. For example, a customer/user interested in determining whether a charter flight may be available from a particular departure location to a desired destination on a given date or date range generally had to contact each of the multiple charter operators to determine whether an appropriate flight was available and what the cost would be. Moreover, for each operator, this generally involved a conversation between the customer/user and a representative of the charter aviation business to discuss the desired flight, followed by an investigation by the charter aviation business to determine what resources were available and determine a cost, and finally resulting in a follow-up conversation between the customer/user and a representative of the charter aviation business to discuss options and pricing. As a practical matter, this has resulted in limited access to information for customer/user and limited ability for charter aviation businesses to identify customers/users to fill available flight resources.

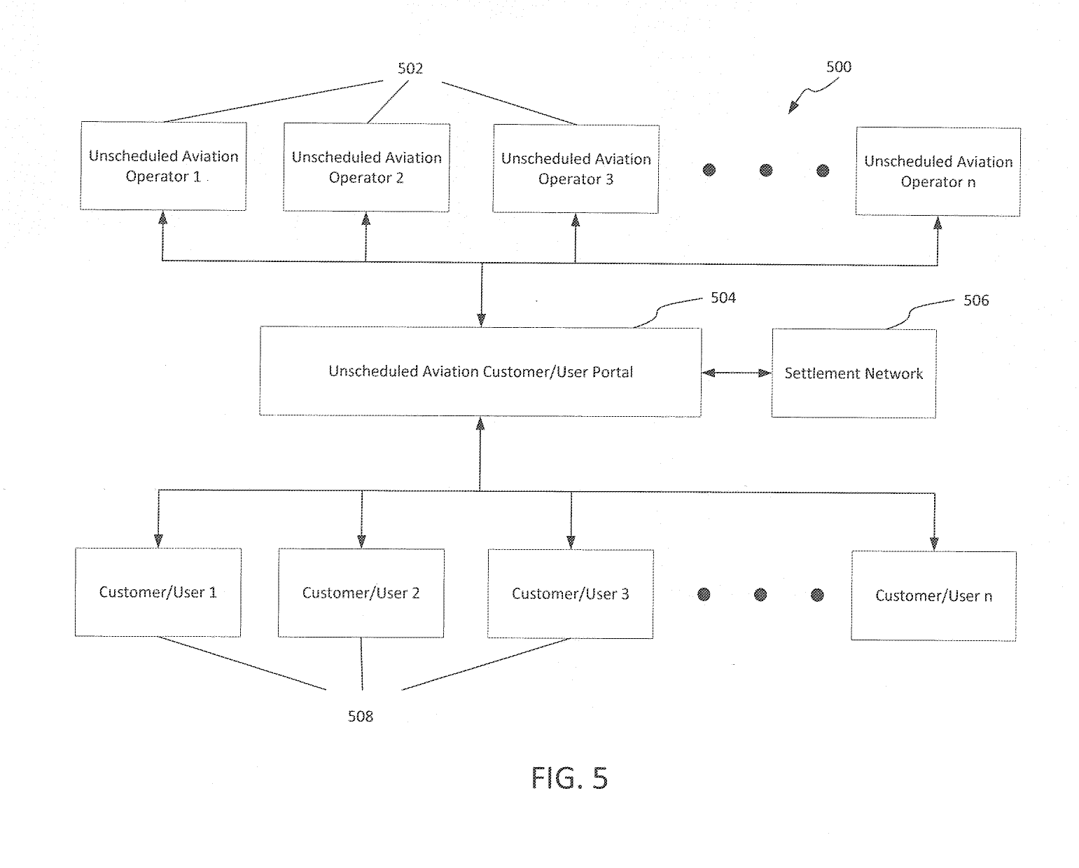

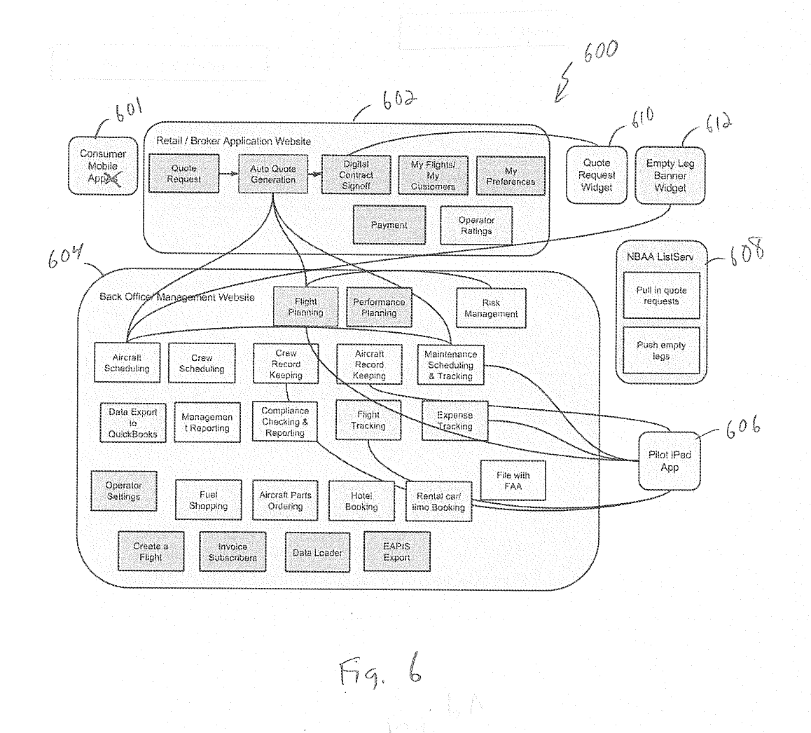

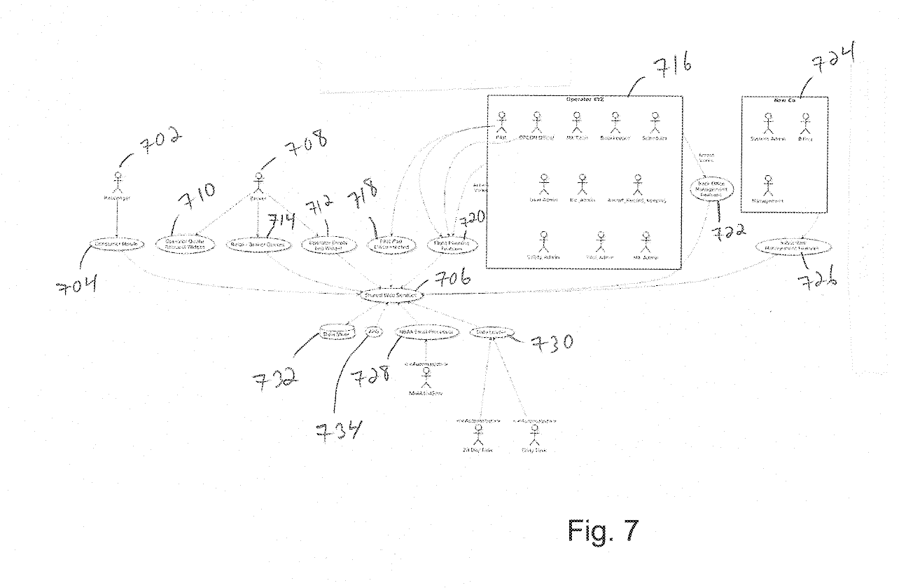

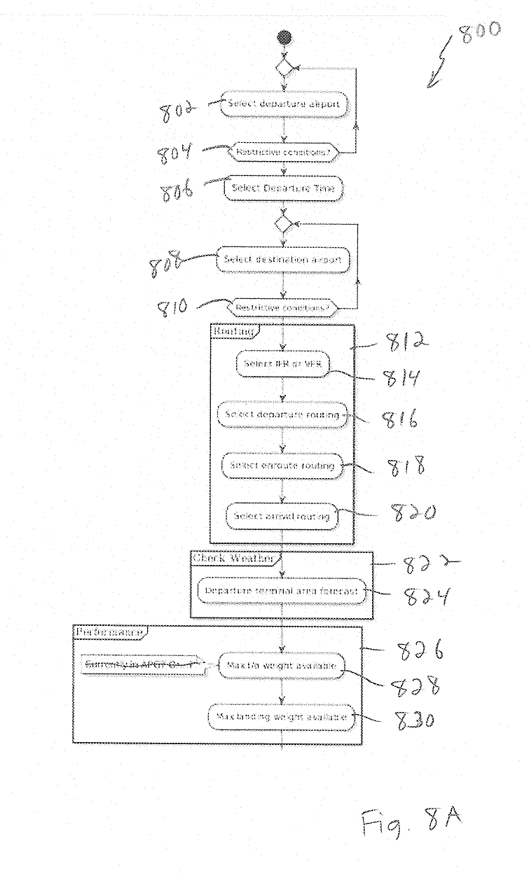

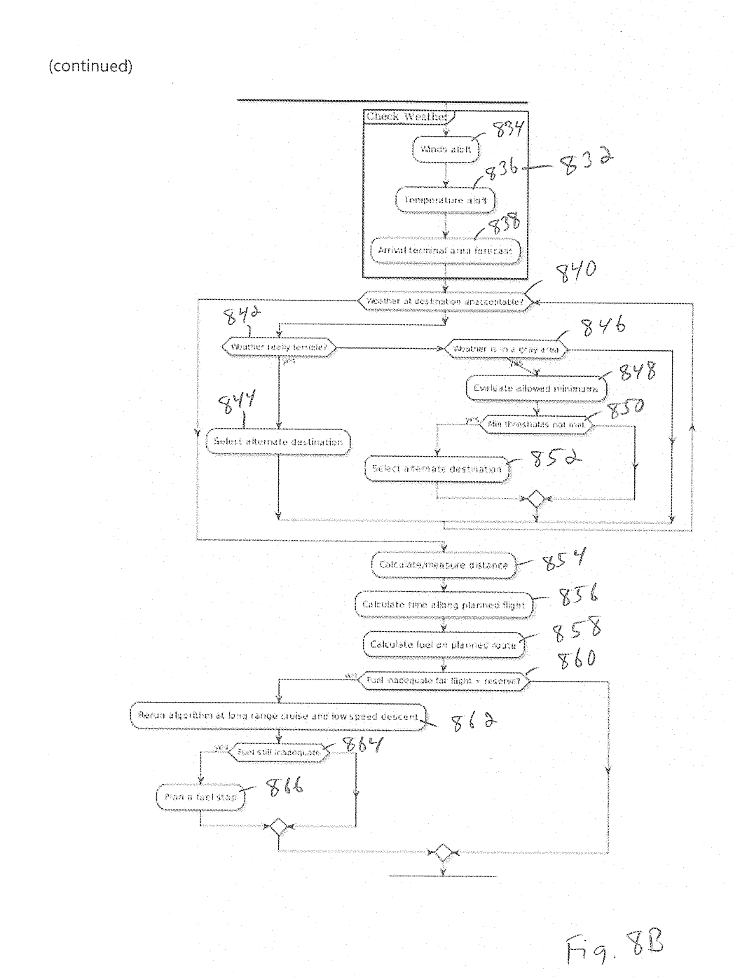

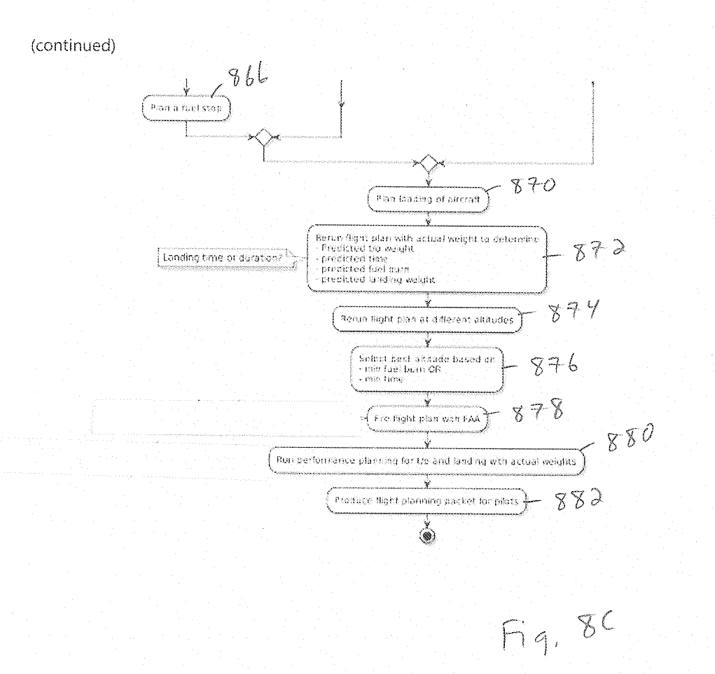

The present invention enhances the efficiency of this marketplace by enabling an automated and centralized platform for distribution of information and execution of contracts. Such a system 500 is illustrated in FIG. 5. The system 500 allows for exchange of information and consummation of transactions between any of a number of unscheduled aviation operators 502 and any of a number of customers/users 508 via unscheduled-flight aviation customer/user portal 504. The unscheduled-flight aviation operators 502 may be, for example, charter aviation operators, cargo flight operators, or emergency air operators. Preferably, each of the operators 502 has a system as described above for receiving and automatically processing requests for availability of flights and generating price quotes, all in real-time, or otherwise allows the portal 504 access to the operator's systems such that the portal 504 can execute such functionality. In this regard, it would be possible for an operator 502 to participate in some of the features of the portal 504, as described below, without such an automated system, but such participation would be limited in certain respects. Accordingly, it is anticipated that at least some operators 502 will have an automated system with functionality as described above.

The customer/user 508 may include, for example, direct charter clients or brokers, government or private emergency air contractors, cargo flight customer/user, and the like. It will generally not be necessary for the customer/user 508 to have custom software or equipment for accessing the system 500. Rather, the system 500 may be implemented as web portal that can be fully accessed and utilized by either return customers or new customers.

The illustrated portal 504 may generate user interface screens similar to those described above that enable the customer/user 508 to input information regarding the purpose, date, and other requirements for a desired flight. In response to such an inquiry from a customer/user, the portal 504 may directly access information of the various operators 502, or may submit an inquiry to an automated information management system of one or more of the operators 502 to collect information responsive to the inquiry from the customer/user 508.

Once the portal 504 has thereby obtained information regarding any available resources from some or all of the operators 502, the information can be presented to the customer/user 508. For example, the customer/user may receive, on a single user interface screen or multiple user interface screens, availability and price quote information from multiple ones of the operators 502. This information may be prioritized in any suitable fashion and may be customizable by the customer/user 508. For example, available flights may be ordered based on cost (e.g., lowest to highest), based on how well the flights match the times and locations of the customer/user requests, based on other user preferences, based on contractual arrangements between the unscheduled aviation operators 502 and an operator of the portal 504 (the business model may allow operators 502 to pay for prioritized listing), or on any other basis.

Alternatively, a customer/user may enter a bid for a particular flight (e.g., I am willing to pay $X for a flight from Denver to Boston during the second week of June”). The operators 502 may then elect to respond to that bid or not. For example, an operator who has an empty leg matching the bid may accept the bid or make a counter-offer. Similarly, operators may post bids for available flights via the portal 504. Other models including auctions of flights may be implemented via portal 504.

The system 500 may further allow the customer/user 508 to book flights and settle payments via the portal 504. Thus, for example, in response to a screen presenting a number of flight options, the user may select one of the flight options for booking. In response, the portal 504 may prompt the customer/user to enter passenger information, cargo information, any other information needed to book the flight, and payment information. For example, the customer/user may direct payment via a credit card or other payment account established with the operator 502 of the selected flight. The portal 504 can then electronically access an appropriate settlement network 506, such as a credit card network, bank network, or other financial network. Upon receiving approval from the settlement network 506, the portal 504 can electronically interface with the booking system of the appropriate operator 502 to book the flight and settle accounts.

Depending on the architecture of the system 500, the portal 504 may then execute a variety of additional functionality related to generating flight plans, executing regulatory filings, scheduling resources and the like. Alternatively, such additional functionality may be executed by the information management system of the operator 502. In either case, the illustrated system 500 allows customer/user to automatically access and compare availability and price information for multiple operators 502, allows the operators 502 better access to customers/users 508 who may be interested in available resources of the operators 502, and improves the overall efficiency of the marketplace.

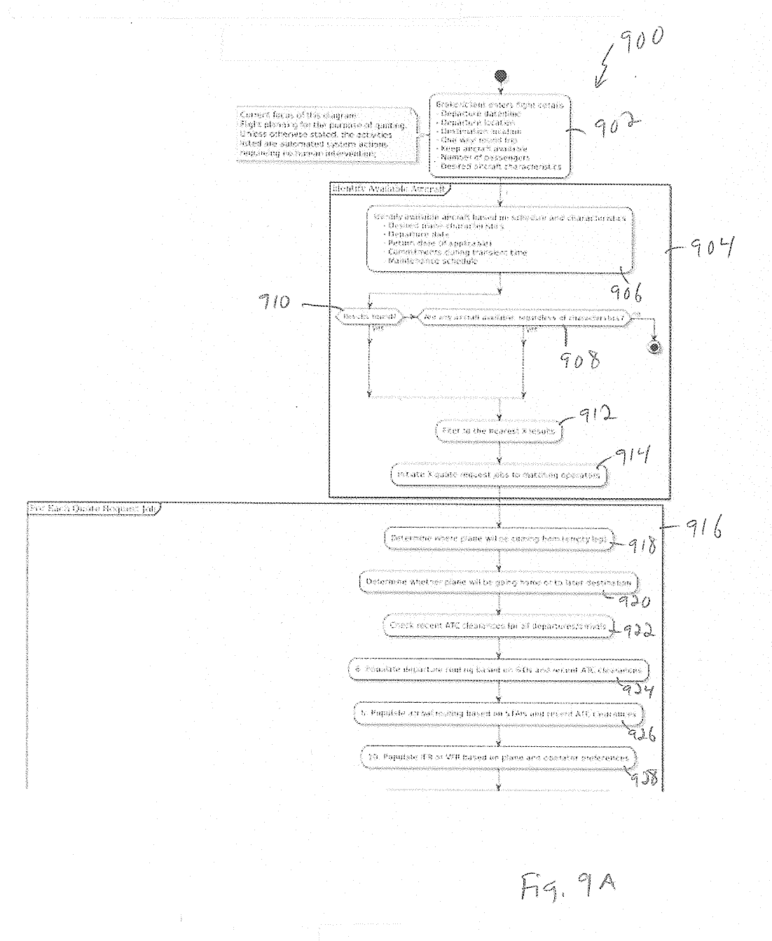

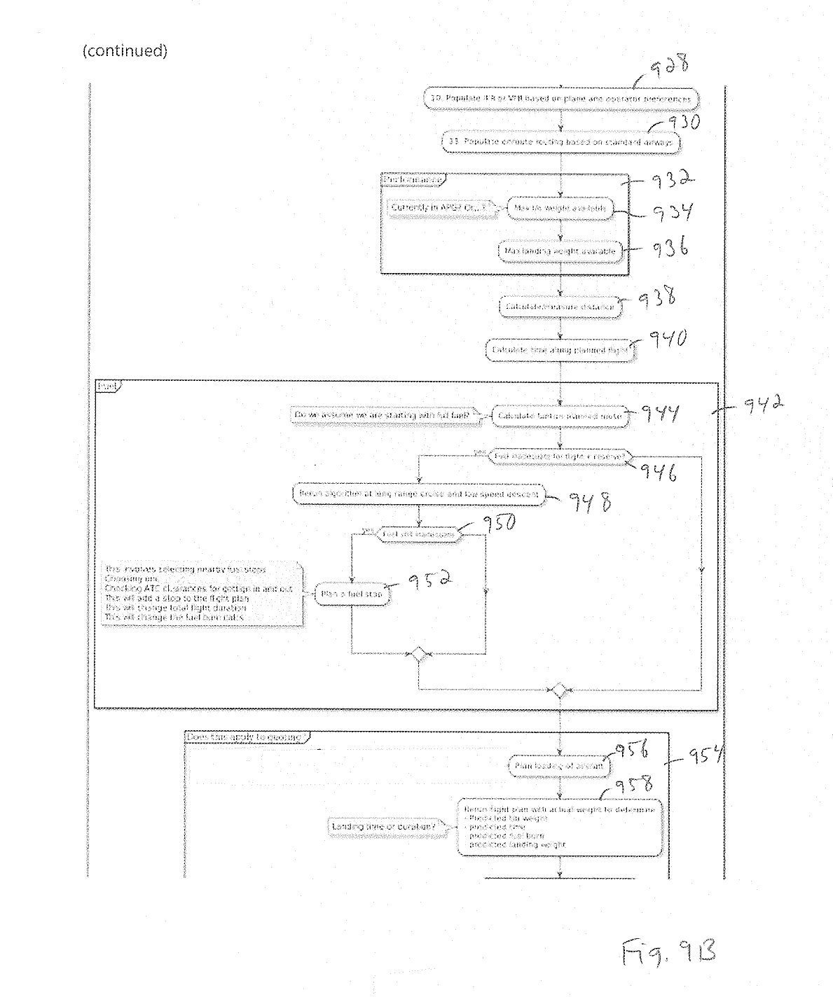

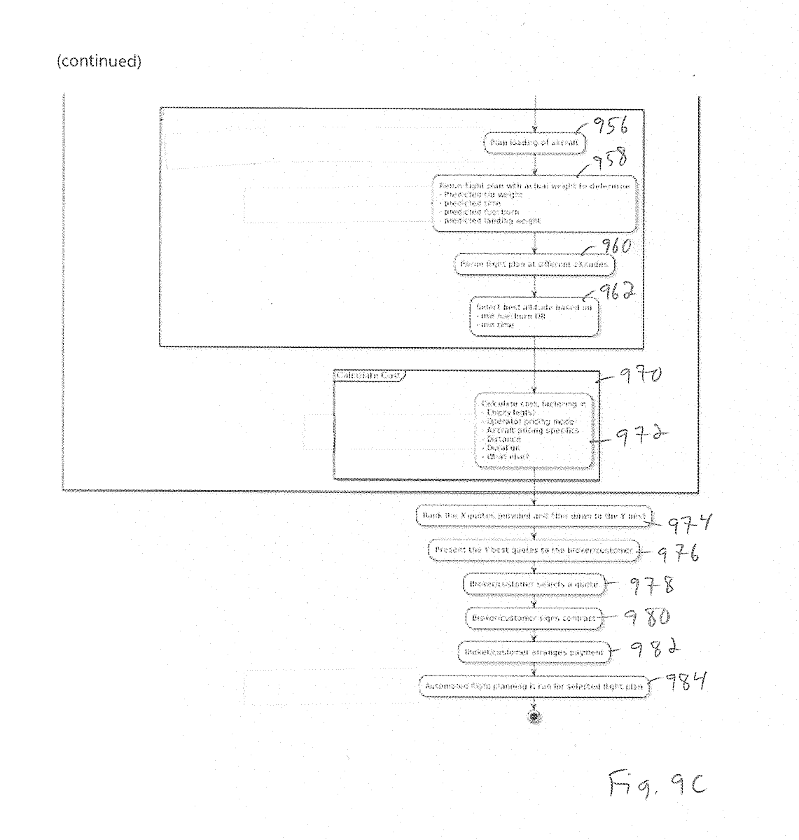

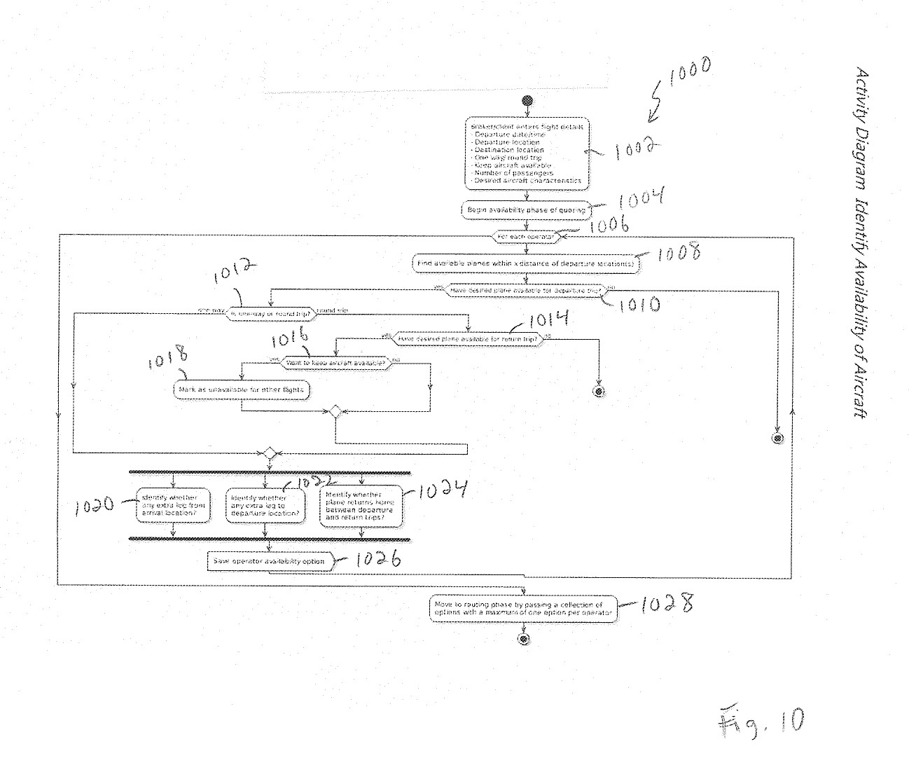

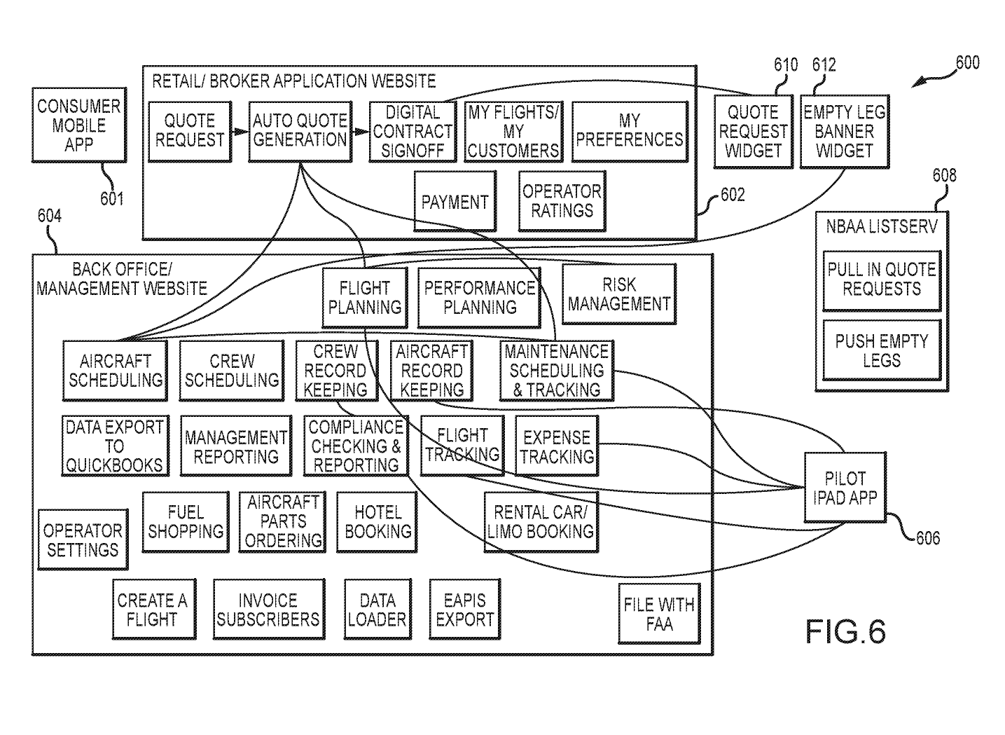

FIG. 6 illustrates an exemplary application environment 600 implementing functionality of the present invention. The illustrated application environment 600 generally includes: a retail/broker application website 602, that (together with the consumer mobile application 601) can execute much of the functionality of the customer/user application platform discussed above; a back office management website 604 that can execute much of the functionality of the management application platform; and a pilot iPad™ application that can execute much of the functionality of the pilot application platform. The environment 600 also includes a National Business Aviation Association (NBAA) ListServ application 608 for pulling in quote requests and pushing empty legs, as well as a quote request widget 610 and an empty leg banner widget 612. The quote request widget 610 may be, for example, a HTML widget that operators can provide via their websites that allows customer/users to request a quote through the central system. This quote request would be for that operator only, not all operators. Similarly, the empty leg banner widget 612 may be an HTML widget that the operators provide via their websites that display empty legs for their operation only, not all operators.

As shown, the retail/broker application website 602 generally is operative for executing functionality including quote requests, automatic quote generation, digital contract signoff, payment, providing “My flights, My customers and My preferences” customized functionality, and operator ratings. The back office/management application 604 functionality includes flight and performance planning, risk management, aircraft and crew scheduling, aircraft and crew record keeping, flight and expense tracking, maintenance scheduling and tracking, data export to accounting, management reporting, compliance checking and reporting, operator settings, fuel shopping, aircraft parts ordering, hotel and rental car booking, regulatory filings, create a flight, invoice subscribers, data loader, and EAPIS data export.

The pilot iPad application 606 functionality includes reviewing flight plans, recording takeoff and landing times, new record keeping including recording expenses and maintenance issues, aircraft record keeping, reporting a squawk and viewing maintenance status, and expense tracking. This application may be used by pilots and crew. FIG. 6 also shows some of the important connections for sharing information between the components 602, 610, 612, 604, and 606, e.g., directly or via a central data store.

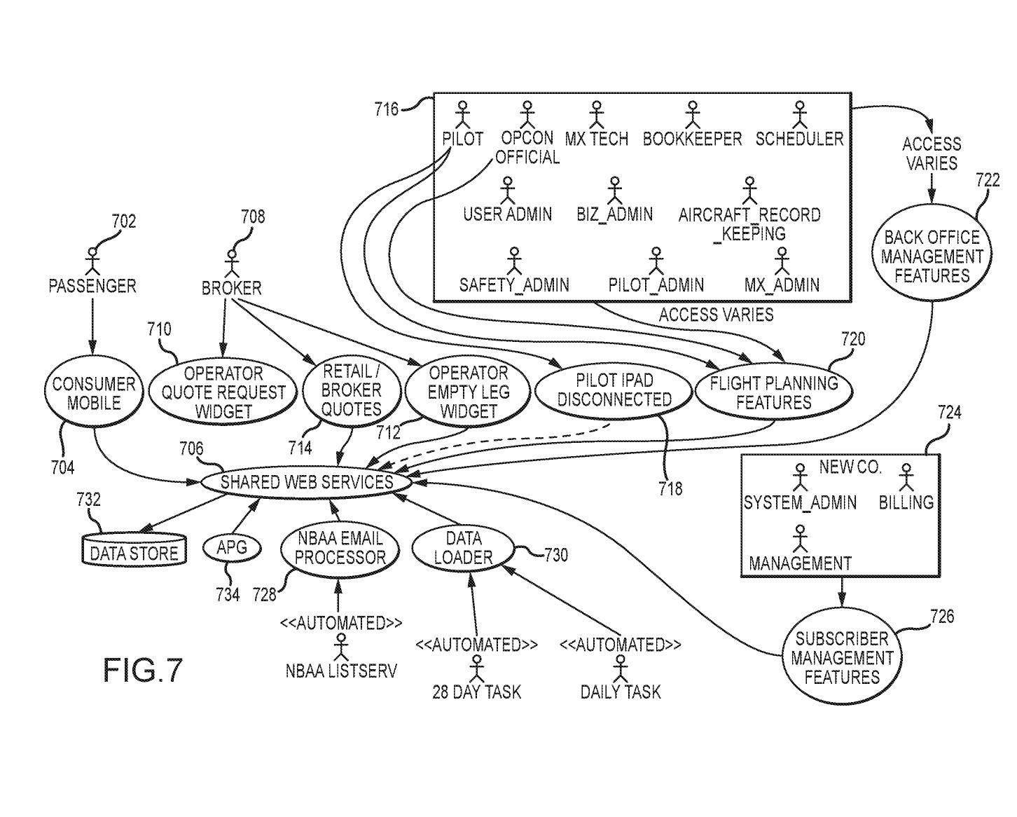

FIG. 7 shows a use case diagram for an unscheduled flight operations system as described above. The system may be accessed by a variety of individuals and automated systems. For example, a passenger 702 using a consumer module 704 may access shared web services 706 for flight information, booking requests and the like. A broker 7018—for example, using a quote request widget 720, an empty leg widget 712, or a retail/broke quote module 714—may access the shared web services 706 to obtain price quotes, information about empty legs or other flight information.

In addition, individuals associated with an operator 716 may access the shared web services 706 using, for example, a Pilot iPad™ module 718, a flight planning module 720, or a back office management module 722. Some examples of such individuals associated with the operator 716 include pilots, operations, officials, mechanics or technicians, bookkeepers, schedulers and various administrative personnel. New entities 724 may use a subscriber management module 726 to gain access to shared web services 706. The shared web services 706 may also be accessed by automated system such as an NBAA email processor 728 and a data loader 730 that loads various data to the services 706 on a daily or other basis. The shared web services 706 may further include interfaces for exchanging information with a data store 732 and an aircraft performance group (APG) module 734.

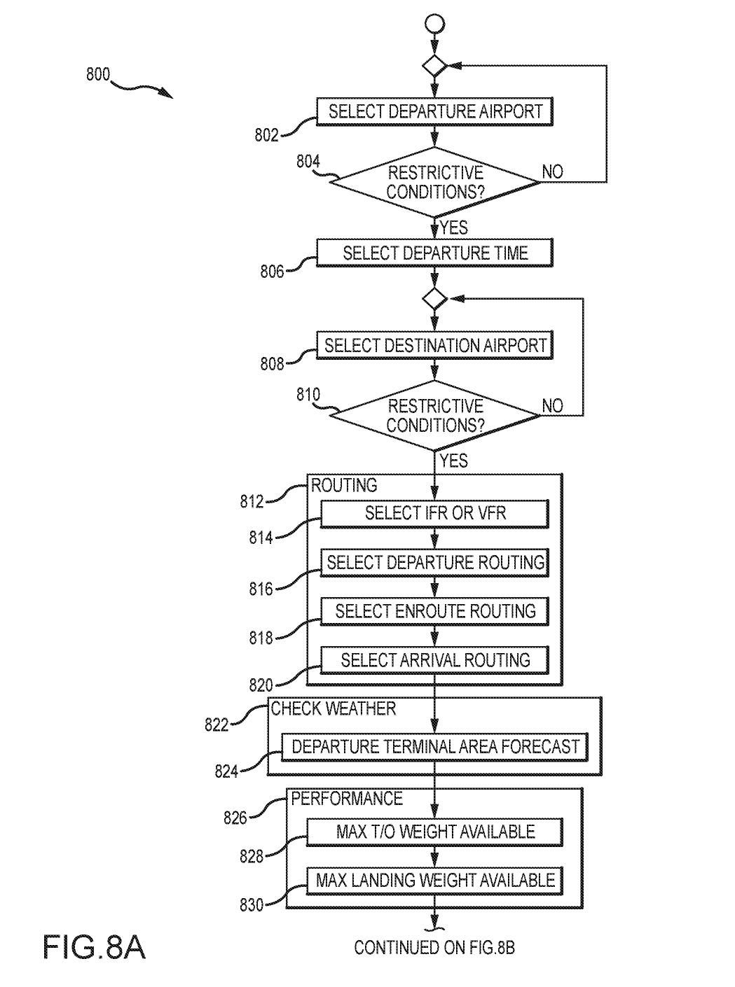

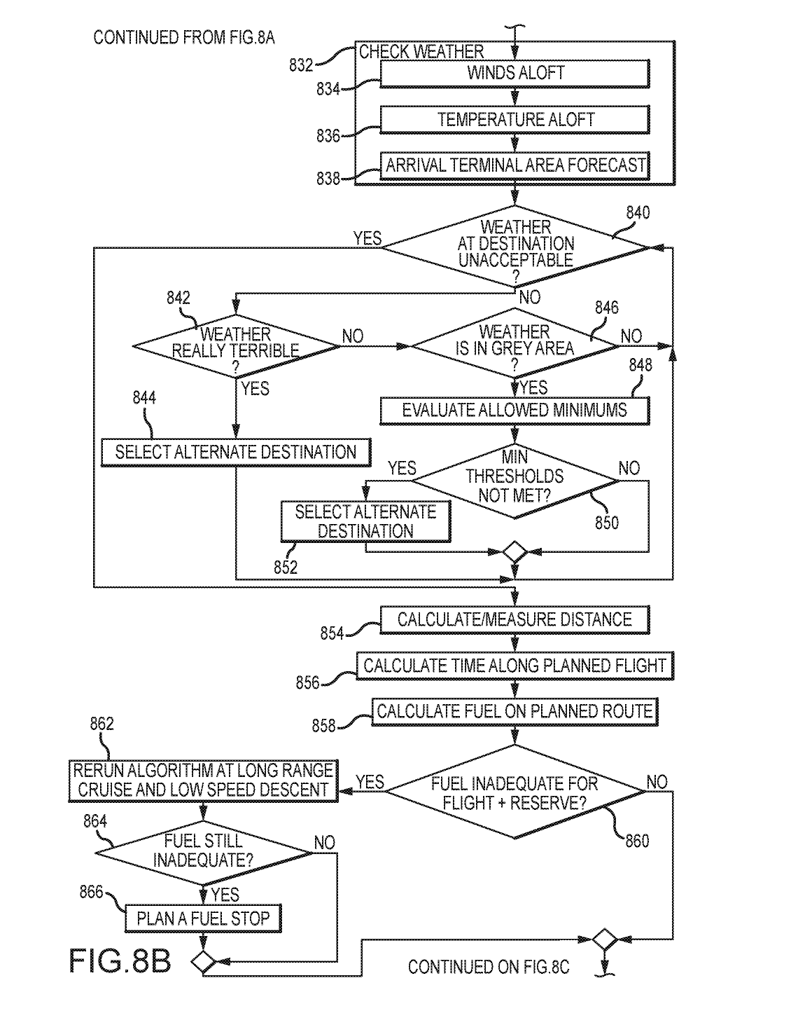

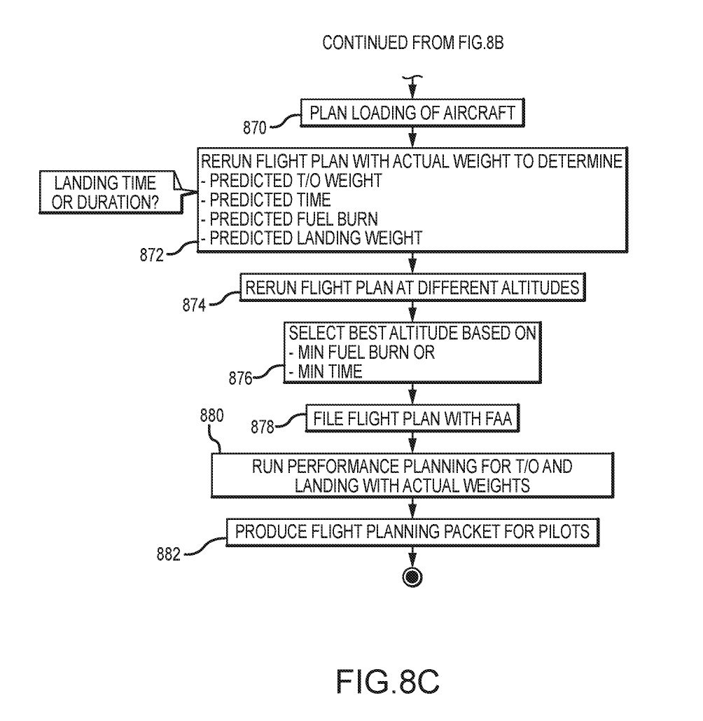

FIGS. 8A-8B are a flowchart illustrating a flight planning process that can be implemented using the unscheduled flight operations in accordance with the present invention. Though it is possible for a human user to access some of this functionality, the system generally operates automatically, e.g., by pulling flight information and other information from the central data store and executing algorithms/functionality. The illustrated process 800 is initiated by operating a flight planning application to select (802) a departure airport. The system may identify (804) any restrictive conditions associated with the selected departure airport. These restrictive conditions may be used to select a different departure airport. The system can also use the application to select (806) a proposed departure time. Next, the system can select (808) a destination airport. Again, the system may identify (810) any restrictive conditions associated with the destination airport and then optionally select a different destination airport.

The flight planning application may then execute a variety of functionality (812) related to routing. Again, this functionality may be automated though it may pull certain inputs from the central data store or otherwise obtain information from a pilot or flight planner. As shown, the routing process (812) involves selecting (814) whether the flight will be conducted in accordance with the instrument flight rules or visual flight rules. The routing will generally then be conducted in three phases including selecting (816) departure routing, selecting (818) enroute routing, and selecting (820) arrival routing.

The system may access weather information (822) at various points in the flight planning process. For example, at the initial flight planning stage, the system may access (824) a forecast for the area of the departure terminal.

For flight planning purposes, the system may also access various performance data (826). This may involve determining the maximum takeoff weight available (828) and maximum landing weight available (830). This information may be available from the APG or accessed from other sources.

Additional weather checks (832) may be conducted at this point. This may include accessing information regarding winds aloft (834), temperature aloft (836), and the forecast for the area of the arrival terminal (838).

The system may then make a determination (840) as to whether the weather at the destination is acceptable. If the weather is not acceptable (842) then an alternate destination may be selected (844). If a determination (846) is made that the weather is questionable, then the system may evaluate (848) allowed minimums and determine (850) if minimum thresholds are met. If the minimums are met then an alternate destination may be selected (852) and the process may be repeated.

Once the destination is determined, the system may calculate or otherwise measure (854) the flight distance and calculate (856) the time for the planned flight. In addition, the fuel required for the planned route may be calculated (858). A determination (860) may then be made as to whether the available fuel and reserve for the aircraft is sufficient. If the fuel is not sufficient, the algorithms may be rerun at long-range cruise and low speed descent parameters (862). If the fuel is still not q (864) then a fuel stop may be planned (866).

Next, loading of the aircraft can be planned (840). The flight plan can then be rerun (872) with the actual weight of the loaded aircraft to determine the predicted takeoff weight, predicted landing weight, predicted flight time, and predicted fuel burn. The flight may be rerun (874) at various altitudes to select to the best altitude for example, based on minimum fuel burn or minimum flight time.

Once the flight plan is thus determined, the system may file (878) the flight plan with the FAA and performance planning may be run (880) for takeoff and landing with the actual weights. A flight planning packet may then be produced (882) for the pilots.

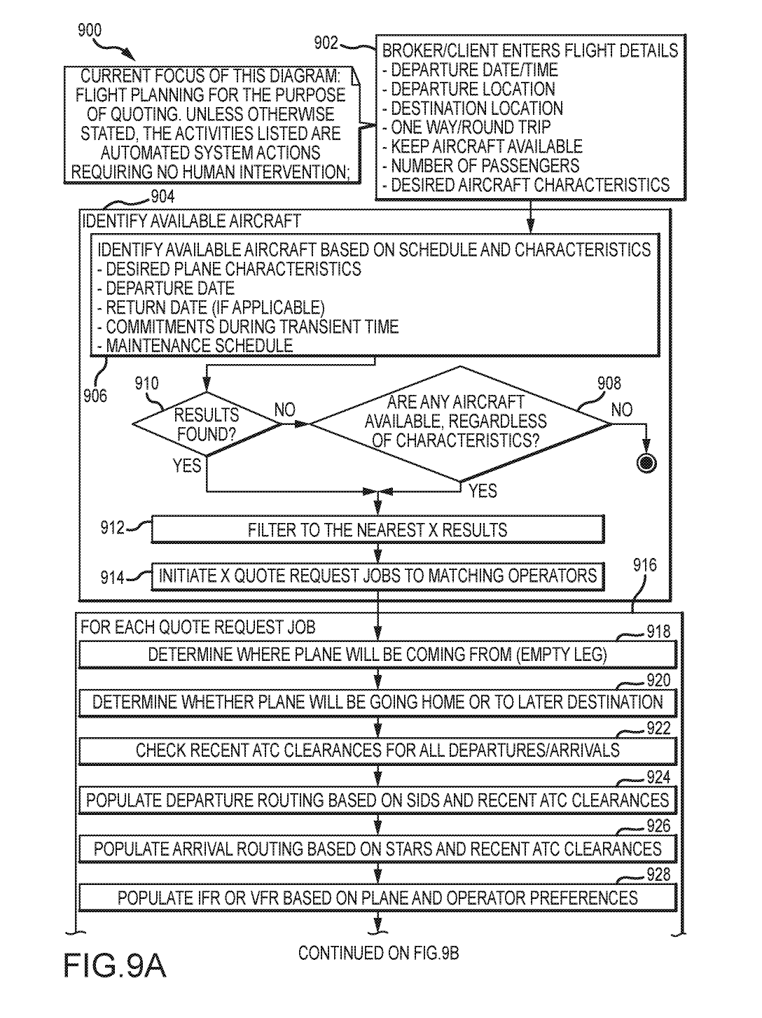

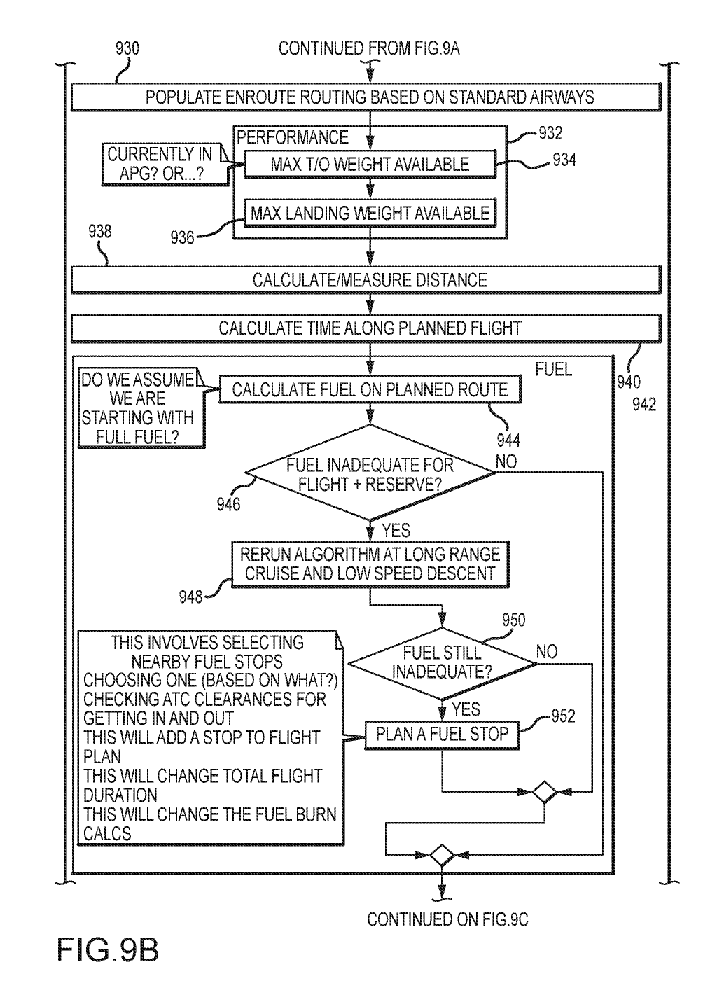

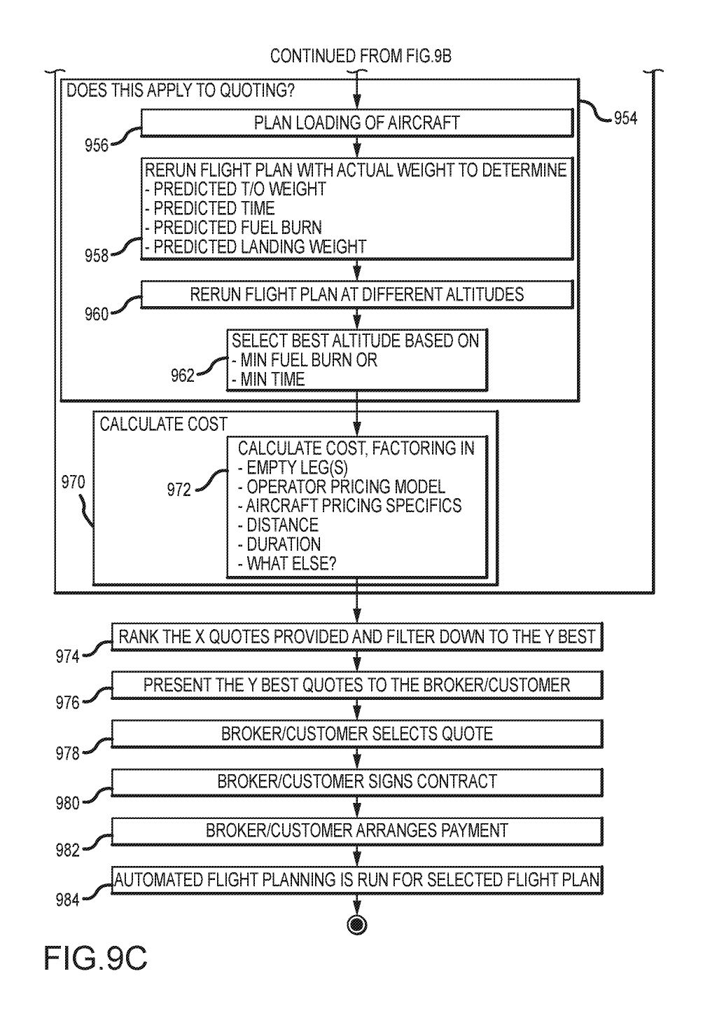

FIGS. 9A-9C show a flowchart that illustrates an automated broker quoting process (900) that can be implemented using the unscheduled flight operation system in accordance with the present invention. The process (900) is initiated by obtaining (902) flight details such as departure date/time, departure location, destination location, one-way or round trip, any need to keep aircraft available, the number of passengers, and the desired aircraft characteristics. It will be appreciated that the illustrated process (900) is largely automated though it may access information from the central data store or otherwise obtain information from the broker or client.

The system then executes a variety of functionality (904) related to identifying available aircraft. In this regard the system identifies (906) available aircraft based on the schedule and the required characteristics. This may involve consideration of the desired plane characteristics, the departure date, a return date if applicable, any commitments of the aircraft during the transient time and the maintenance schedule of aircraft under consideration. If no available aircraft are identified (908) then the broker is so notified and the process is terminated. If results are found (910) then the system may filter the available aircraft to consider a predetermined best matching (912) and a quote request may initiated (914).

The system can then execute a variety of functionality (916) related to generating a quote. In this regard, the system determines (918) where the plane will be coming from (i.e., if there will thus be an empty leg). The system further determines (920) whether the plane will be going home or to another destination at the conclusion of the flight. The system next checks (922) recent air traffic control clearances for all departures and arrivals. The system can then populate (924) departure routing based on recent ACT clearances, populate (926) arrival routing based and recent ACT clearances, and populate (928) the instrument flight rules flight plan or visual flight rules flight plan based on the plane and operator preferences. Finally, the system can populate (903) the enroute routing based on standard airways.

At this point, the system may access (932) performance data including the maximum takeoff weight available (934) and the maximum landing weight available (936). In addition, the system can calculate or otherwise measure (938) the flight distance and calculate (940) the flight time along the planned flight path.

The system then executes a variety of functionality (942) relating to consideration of fuel needs. In this regard, the system initially calculates (944) the fuel required on the planned route. If the fuel required for the flight and reserve is inadequate (946) then the fuel algorithm may be rerun (948) at long range cruise and low speed descent parameters. If the fuel remains inadequate (950) then a fuel stop is planned (952).

The system may also execute a variety of functionality (954) related to the loading of the aircraft in relation to generating a price quote. In this regard, based on information pulled from the central data store, the system may plan (956) loading of the aircraft and rerun (958) the flight plan with the actual weights to determine the predicted takeoff, predicted landing weight, predicted time of flight, and predicted fuel burn. The flight plan may be rerun (960) at different altitudes to select (962) the best altitude based on minimum fuel burn or minimum flight time. Based on all this information, the system can calculate (970) cost. This calculation (972) may factor in empty legs, an operator pricing model, aircraft pricing specifies, distance, duration, and any other relevant factors.

This process may be repeated for a number of aircraft that are potentially acceptable. The system can then rank (974) a predetermined number of quotes and, if necessary, filter that down to a desired number of best quotes. The predetermined number of best quotes can then be presented (976) to the broker/customer. The broker/customer then selects (978) a quote and signs (980) (e.g., electronically) a contract and arranges (982) payment. Automated flight planning may then be run (984) for the selected flight plan.

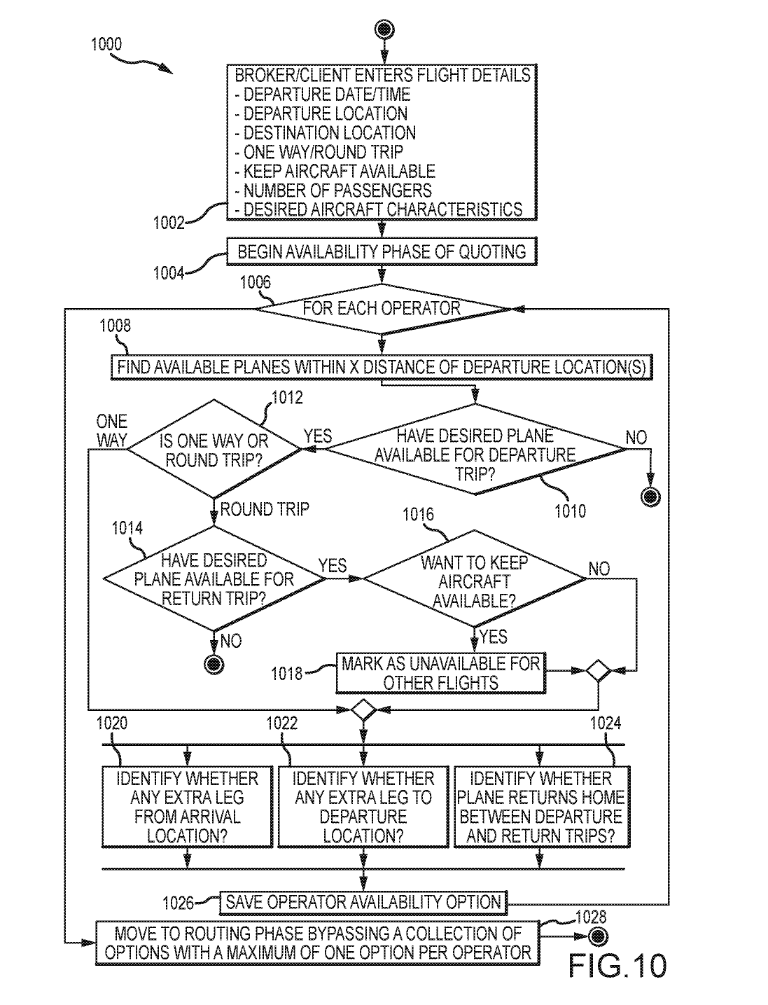

FIG. 10 is flowchart illustrating a process 1000 for identifying available aircraft that can be implemented using the unscheduled flight operating system in accordance with the present invention. The illustrated process 1000 may be partially or fully automated based on certain information pulled from the central data store or otherwise obtained. The illustrated process 1000 is initiated by pulling (1002) flight details such as departure date and time, departure location, destination location, one-way or round trip, any desire to keep aircraft available, the number of passengers, and desired aircraft characteristics. Based on this information, the system begins (1004) the availability phase of quoting. In this regard, the system executes (1006) a variety of functionality on an operator-by-operator basis. Specifically, the system finds (1008) available planes within a predetermined distance of the departure location and determines (1010) whether any planes are available for the desired trip. If no planes are available, the broker is so notified and the process is terminated. If planes are potentially available, the system determines (1012) whether the desired trip is a one-way or round trip flight. If it is a round trip flight, then a determination is made (1014) whether a plane is available for the return trip. If no plane is available for the return trip, the broker is so notified and the process is terminated.

Next, the system determines (1016) whether it is desired to keep aircraft available. If so, the aircraft is marked (1018) as unavailable for other flights. The system then identifies (1020) whether any extra leg is required for the arrival location, whether is required for the departure location (1022) and whether the aircraft needs to return home between the departure and return trips (1024). The system can also save (1026) the operator availability option. Finally, the system moves (1028) to the routing phase by passing a collection of options with a maximum of one option per operator.

The invention, as thus described, satisfies a number of objectives in relation to unscheduled flight operations. In this regard, the invention provides a comprehensive private aviation business process management platform that eliminates redundant data entry and reduces the number of human interactions necessary to complete the private aviation/aircraft charter business workflow. In addition, the invention system provides an “operator first” charter aviation application that supports all areas of the business. Automation of the quoting process will mean that operators are able to deliver many more quotes to brokers/customers/users with the same manpower, thereby increasing sales. The system will also reduce operations costs for operators and, reduce the time and repetition in the flight planning process. It is further anticipated that the invention system will attract so many operators to the system that it facilitates negotiating advantageous fuel, parts, hotel and rental car prices with vendors, and, attract the critical mass of operators to the system needed in order to significantly reduce subscriber percentages of empty legs. Moreover, it is believed that the invention provides an application so easy and seamless to use that end users and customers become willing to book charter flights directly rather than going through brokers.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A data processing system for managing information related to an aviation environment involving unscheduled flight operations, comprising:
a central data store for storing flight information related to the unscheduled operations in the aviation environment;
a customer/user application platform for use by a direct client or broker for requesting quotes and executing contracts relating to one or more flights;
a management application platform for entering and accessing portions of said flight information relating to the unscheduled-flight aviation environment;
a pilot application platform, for use by pilots of said flights, for entering and accessing portions of said flight information related to said unscheduled-flight aviation environment; and
a central data store interface for operatively interconnecting said central data store to each of said customer/user application platform, said management application platform, and said pilot application platform, said central data store interface defining a data structure for exchange of said flight information between said data store and each of said customer/user application platform, said management application platform, and said pilot application platform, said central data store interface being operative for:
defining a set of data fields relating to said flight information; and
first receiving a first item of said flight information from a first one of said customer/user application platform, said management application platform, and said pilot application platform;
storing said first set of said flight information in said central data store, wherein said first set of said flight information is associated with metadata indexing said first set of said flight information to one or more of said defined data fields; and
second receiving a request for a second set of said flight information, the same or different than said first set of said flight information, regarding one or more of said flights from second one, different than said first one, of said customer/user application platform, said management application platform, and said pilot application platform;
processing said request to identify one or more of said defined data fields, implicated by said request and, based at least in part on said implicated data fields to identity information stored in said central data store that is responsive to said request; and
generating a response to said request from said second one of said customer/user application platform, said management application platform, and said pilot application platform, by populating a record with data from said central data store based at least in part on said first item of first flight information received from said first one of said customer/user application platform, said management application platform, and said pilot application platform.

2. A data processing system as set forth in claim 1, wherein said management application platform is operative for one or more of flight planning, aircraft scheduling, and crew scheduling.

3. A data processing system as set forth in claim 1, wherein said management application is operative for one or more of crew record keeping, aircraft record keeping, and maintenance scheduling or tracking.

4. A data processing system as set forth in claim 1, wherein said management application is operative for one or more of flight tracking, expense tracking, and compliance checking and reporting.

5. A data processing system as set forth in claim 1, wherein said management application is operative for regulatory filings.

6. A data processing system as set forth in claim 1, wherein said management application is operative for one or more of fuel shopping, aircraft parts ordering, hotel booking, and rental car/limousine booking.

7. A data processing system as set forth in claim 1, wherein said pilot application platform is operative for viewing a flight plan.

8. A data processing system as set forth in claim 1, wherein said pilot application platform is operative for recording flight log information.

9. A data processing system as set forth in claim 1, wherein pilot application platform is operative for one or more of crew record keeping, aircraft record keeping, viewing maintenance status, and expense tracking.

10. A data processing system as set forth in claim 1, wherein said management application platform is operative for pulling in quote requests and matching quote requests to available equipment and resources.

11. A data processing system as set forth in claim 1, wherein items of flight information from each of said customer/user application platform and said pilot application platform are stored in said central data store and are available for access by said management application platform using said control data store interface.

12. A data processing system as set forth in claim 11, wherein said management application platform is operative for obtaining first and second items of flight information, wherein the first and second items are processed to facilitate combined analysis.

13. A data processing system as set forth in claim 12, wherein the first and second items are selected based on compatibility with respect to one or more factors.

14. A data processing system as set forth in claim 12, wherein at least one of the first and second items is adjusted to account for variation with respect to one or more factors.

15. A data processing system as set forth in claim 1, wherein said central data store interface is further operative for analysis risk factors related to said aviation environment.

16. A data processing system as set forth in claim 15, wherein said central data store interface analyzes said risk factors by accessing data from said central data store.

17. A data processing system as set forth in claim 15, wherein said central data store interface analyzes said risk factors by accessing an external data source.

18. A method for managing information related to an unscheduled-flight aviation environment, comprising:
providing a central data store for storing aviation information;
first receiving a first set of first flight information from a first one of said customer/user application platform, a management application platform, and a pilot application platform;
storing said first set of first flight information in said central data store, wherein said first flight information is associated with metadata indexing said first flight information to one or more defined data fields;
second receiving a request for second flight information regarding one or more charter flights from a second one, different than said first one, of said customer/user application platform, said management application platform, and said pilot application platform;
processing said request to identify one or more of said defined data fields, implicated by said request and, based at least in part on said implicated data fields, to identity information stored in said central data store that is responsive to said request; and
generating a response to said request from said second one of said customer/user application platform, said management application platform, and said pilot application platform, by populating a record with data from said central data store based at least in part on said first set of first flight information received from said first one of said customer/user application platform, said management application platform, and said pilot application platform.

19. A method as set forth in claim 18, wherein said management application platform is operative for one or more of flight planning, aircraft scheduling, and crew scheduling.

20. A method as set forth in claim 18, wherein said management application is operative for one or more of crew record keeping, aircraft record keeping, and maintenance scheduling or tracking.

21. A method as set forth in claim 18, wherein said management application is operative for one or more of flight tracking, expense tracking, and compliance checking and reporting.

22. A method as set forth in claim 18, wherein said management application is operative for regulatory filings.

23. A method as set forth in claim 18, wherein said management application is operative for one or more of fuel shopping, aircraft parts ordering, hotel booking, and rental car/limousine booking.

24. A method as set forth in claim 18, wherein said pilot application platform is operative for viewing a flight plan.

25. A method as set forth in claim 18, wherein said pilot application platform is operative for recording flight log information.

26. A method as set forth in claim 18, wherein pilot application platform is operative for one or more of crew record keeping, aircraft record keeping, viewing maintenance status, and expense tracking.

27. A method as set forth in claim 18, wherein said management application platform is operative for pulling in quote requests and matching quote requests to available equipment and resources.

28. A method as set forth in claim 15, wherein items of flight information from each of said customer/user application platform and said pilot application platform are stored in said central data store and are available for access by said management application platform using said control data store interface.

29. A method as set forth in claim 28, wherein said management application platform is operative for obtaining first and second items of flight information, wherein the first and second items are processed to facilitate combined analysis.

30. A method as set forth in claim 29, wherein the first and second items are selected based on compatibility with respect to one or more factors.

31. A method as set forth in claim 29, wherein at least one of the first and second items is adjusted to account for variation with respect to one or more factors.

32. A method as set forth in claim 18, further comprising operating a processor to analyze risk factors related to said aviation environment.

33. A method as set forth in claim 32, wherein said processor accesses information from said central data store to analyze said risk factors.

34. A method as set forth in claim 32, wherein said processor accesses information from an external data source to analyze said risk factors.

35-56. (canceled)
